(19) United States
(12) Patent Application Publication
(10) Pub. No.: US 2026/0352386 A1
(43) Pub. Date: Nov. 5, 2026

(54) COMMUNICATION METHOD AND APPARATUS

(71) Applicant: HUAWEI TECHNOLOGIES CO., LTD., Shenzhen (CN)

(72) Inventors: Na Gao, Shanghai (CN); Hao Tang, Shanghai (CN); Lei Dong, Shanghai (CN); Jianglei Ma, Ottawa (CA)

(21) Appl. No.: 19/728,980

(22) Filed: Jul. 2, 2026

Related U.S. Application Data
(63) Continuation of application No. PCT/CN2024/133455, filed on Nov. 21, 2024.

(30) Foreign Application Priority Data
Jan. 5, 2024 (CN) 202410026823.5

(51) Int. Cl. H04L 5/00; H04L 1/00; H04L 27/26

(52) U.S. Cl. CPC H04L 5/0005; H04L 1/0003; H04L 27/261

(57) ABSTRACT

A communication method includes: determining a first time-frequency resource and a second time-frequency resource, where a duplex type corresponding to the first time-frequency resource is non-full-duplex, a duplex type corresponding to the second time-frequency resource is full-duplex, and the first time-frequency resource and the second time-frequency resource correspond to different mapping priorities; and sending a first signal based on the first time-frequency resource and the second time-frequency resource.

### CROSS-REFERENCE TO RELATED APPLICATIONS

This application is a continuation of International Application No. PCT/CN2024/133455, filed on Nov. 21, 2024, which claims priority to Chinese Patent Application No. 202410026823.5, filed on Jan. 5, 2024. The disclosures of the aforementioned applications are hereby incorporated by reference in their entireties.

### TECHNICAL FIELD

This disclosure relates to the communication field, and in particular, to a communication method and apparatus.

### BACKGROUND

Performance requirements such as communication reliability and latency have gradually become key indicators to be considered in communication scenarios. For example, ultra-reliable low latency communication (URLLC) is one of the three major application scenarios of the 5th generation (5G) communication system. As a breakthrough for the mobile communication industry to penetrate vertical industries, URLLC is critical for widespread applications in fields such as self-driving, industrial manufacturing, the internet of vehicles, and smart grids. In addition, URLLC has been comprehensively enhanced in the new radio (NR) release (R) 16 stage of the 3rd generation partnership project (3GPP).

Currently, how to ensure the requirements of corresponding services in different communication scenarios becomes an urgent problem to be resolved.

### SUMMARY

Embodiments of this disclosure provide a communication method and apparatus. Different time-frequency resources may correspond to different mapping priorities, to improve the transmission reliability of signals.

To achieve the foregoing objective, this disclosure uses the following technical solutions.

According to a first aspect, a communication method is provided, including: determining a first time-frequency resource and a second time-frequency resource, where a duplex type corresponding to the first time-frequency resource is non-full-duplex, a duplex type corresponding to the second time-frequency resource is full-duplex, and the first time-frequency resource and the second time-frequency resource correspond to different mapping priorities; and sending a first signal based on the first time-frequency resource and the second time-frequency resource. For example, the first signal may be mapped to the first time-frequency resource and the second time-frequency resource that correspond to a first channel. The first channel may be a communication channel for transmitting the first signal.

In this embodiment of this disclosure, a full-duplex time-frequency resource and a non-full-duplex time-frequency resource may correspond to different mapping priorities. Signals may be sent on different time-frequency resources based on different mapping priorities, to ensure their transmission reliability.

In a possible design, the first signal includes at least one of the following: demodulation reference signals (DMRS) and data signals.

This embodiment of this disclosure provides a plurality of possible forms of the first signal, to ensure the transmission reliability of corresponding types of signals in different scenarios.

In a possible design, that the first time-frequency resource and the second time-frequency resource have different mapping priorities is represented in at least one of the following manners: The DMRSs are mapped to the first time-frequency resource in a first mapping manner, the DMRSs are mapped to the second time-frequency resource in a second mapping manner, and a mapping priority corresponding to the first mapping manner is different from a mapping priority corresponding to the second mapping manner; and a mapping priority of the data signals mapped to the first time-frequency resource is different from a mapping priority of the data signals mapped to the second time-frequency resource.

In this embodiment of this disclosure, different types of signals may correspond to different mapping priorities on the full-duplex time-frequency resource and the non-full-duplex time-frequency resource. Therefore, different types of signals are mapped to the full-duplex time-frequency resource and the non-full-duplex time-frequency resource in corresponding mapping manners for transmission, to ensure the transmission reliability of corresponding types of signals.

In a possible design, that the mapping priority corresponding to the first mapping manner is different from the mapping priority corresponding to the second mapping manner is represented in at least one of the following manners: A density of a resource occupied by the DMRSs on the first time-frequency resource is lower than a density of a resource occupied by the DMRSs on the second time-frequency resource; time domain densities of the DMRSs on different time-frequency resources are the same, and a frequency domain density of the DMRSs on the first time-frequency resource is lower than a frequency domain density of the DMRSs on the second time-frequency resource; frequency domain densities of the DMRSs on different time-frequency resources are the same, and a time domain density of the DMRSs mapped to the first time-frequency resource is lower than a time domain density of the DMRSs on the second time-frequency resource; or a frequency domain density of the DMRSs on the first time-frequency resource is lower than a frequency domain density of the DMRSs on the second time-frequency resource, and a time domain density of the DMRSs on the first time-frequency resource is lower than a time domain density of the DMRSs on the second time-frequency resource.

This embodiment of this disclosure provides a plurality of manners of mapping the DMRSs to different time-frequency resources. A DMRS density configured for the full-duplex time-frequency resource is higher than a DMRS density configured for the non-full-duplex time-frequency resource, so that proper DMRS densities are used to perform sending on corresponding time-frequency resources in different scenarios. This improves reliability of parsing the data signals based on the DMRSs on the full-duplex time-frequency resource and the non-full-duplex time-frequency resource.

In a possible design, the method further includes: sending or receiving first information. The first information is used to determine at least two mapping manners corresponding to the DMRSs. The at least two mapping manners corresponding to the DMRSs include the first mapping manner and the second mapping manner, and different duplex types correspond to different mapping manners.

In this embodiment of this disclosure, a plurality of DMRS mapping manners may be configured by using the first information, so that mapping may be performed in proper mapping manners for different time-frequency resources based on the first information, thereby ensuring that the data signals are parsed more accurately based on the DMRSs on different time-frequency resources. In a possible design, the first information may be carried in one or more of the following: a protocol predefinition, a network configuration, higher layer signaling, or physical layer signaling.

This embodiment of this disclosure provides a plurality of manners of carrying the first information, so that proper manners are selected to send the first information in different scenarios, to improve universality.

In a possible design, the mapping manner corresponding to the duplex type is predefined in a protocol; the first information further indicates the duplex type corresponding to the mapping manner; or the method further includes: sending or receiving second information, where the second information further indicates the duplex type corresponding to the mapping manner.

This embodiment of this disclosure provides a plurality of possible forms in which the mapping manner corresponds to the duplex type, and proper manners may be selected to indicate a correspondence between the mapping manner and the duplex type in different scenarios. In this way, any type of signal is mapped to the full-duplex time-frequency resource and the non-full-duplex time-frequency resource in a proper mapping manner, to ensure the transmission reliability of the signal.

In a possible design, the second information may be carried in one or both of the following: higher layer signaling or physical layer signaling.

This embodiment of this disclosure provides a plurality of manners of carrying the second information, so that proper manners are selected to send the second information in different scenarios, to improve universality.

In a possible design, the first signal includes the DMRSs, and the DMRSs include first DMRSs and second DMRSs. The method further includes: sending or receiving third information, where the third information is used to determine a mapping manner corresponding to the first DMRSs, and the first DMRSs are mapped to the first time-frequency resource and the second time-frequency resource; and sending or receiving fourth information, where the fourth information is used to determine a mapping manner corresponding to the second DMRSs, and the second DMRSs are mapped to the second time-frequency resource.

In this embodiment of this disclosure, different DMRSs may be divided based on the mapping manners, and one or more types of DMRSs may be separately mapped to the full-duplex time-frequency resource and the non-full-duplex time-frequency resource, so that it is ensured that the data signals are parsed more accurately based on the DMRSs on different time-frequency resources.

In a possible design, the third information may be carried in one or more of the following: a protocol predefinition, a network configuration, higher layer signaling, or physical layer signaling.

This embodiment of this disclosure provides a plurality of manners of carrying the third information, so that proper manners are selected to send the third information in different scenarios, to improve universality.

In a possible design, the fourth information may be carried in one or more of the following: a protocol predefinition, a network configuration, higher layer signaling, or physical layer signaling.

This embodiment of this disclosure provides a plurality of manners of carrying the fourth information, so that proper manners are selected to send the fourth information in different scenarios, to improve universality.

In a possible design, the method further includes: performing rate matching or puncturing on a time-frequency resource symmetric to the second DMRSs.

In this embodiment of this disclosure, the rate matching or puncturing may be performed on the time-frequency resource symmetric to the second DMRSs, and manners of using the resources for different transmission directions may be flexibly configured.

In a possible design, the first signal includes the DMRSs, and the method further includes: sending or receiving fifth information. The fifth information is used to determine a mapping manner corresponding to the DMRSs. A density of a resource occupied by the DMRSs is a first value. The mapping manner corresponding to the DMRSs is represented in the following manner: A density of a resource occupied by the DMRSs on the second time-frequency resource is higher than a density of a resource occupied by the DMRSs on the first time-frequency resource.

In this embodiment of this disclosure, when an overall DMRS density remains unchanged, different DMRS densities may be allocated to different time-frequency resources, to ensure that the data signals are parsed more accurately based on the DMRSs on different time-frequency resources.

In a possible design, the fifth information may be carried in one or more of the following: a protocol predefinition, a network configuration, higher layer signaling, or physical layer signaling.

This embodiment of this disclosure provides a plurality of manners of carrying the fifth information, so that proper manners are selected to send the fifth information in different scenarios, to improve universality.

In a possible design, the first signal includes the data signals, and the data signals are sequentially mapped to the first time-frequency resource and the second time-frequency resource.

In this embodiment of this disclosure, the data signals may be preferentially mapped to the non-full-duplex time-frequency resource, to ensure the transmission reliability of the data signals.

In a possible design, the data signals include first-type data signals and second-type data signals, a data priority of the first-type data signals is different from a data priority of the second-type data signals, and an order in which different data signals are sequentially mapped to the first time-frequency resource and the second time-frequency resource is determined based on the data priorities.

In this embodiment of this disclosure, different types of data signals may have different data priorities. The sequence of mapping different data signals may be determined based on different data priorities, to ensure the transmission reliability of different types of data signals on the non-full-duplex time-frequency resource and the full-duplex time-frequency resource.

In a possible design, the first signal includes the data signals. Sending the data signals based on the first time-frequency resource and the second time-frequency resource meets at least one of the following: a quantity of retransmissions corresponding to the data signals transmitted on the second time-frequency resource is greater than a quantity of retransmissions corresponding to the data signals transmitted on the first time-frequency resource; a modulation and coding scheme MCS) for transmitting the data signals on the second time-frequency resource is lower than an MCS for transmitting the data signals on the first time-frequency resource; and a quantity of layers for transmitting the data signals on the second time-frequency resource is less than a quantity of layers for transmitting the data signals on the first time-frequency resource.

In this embodiment of this disclosure, the data signals may have different configurations on the non-full-duplex time-frequency resource and the full-duplex time-frequency resource, to ensure the transmission reliability of the data signals on the corresponding time-frequency resources.

In a possible design, the different time-frequency resources are determined in any one of the following manners: predefined in a protocol; or determined through division based on a channel measurement result.

This embodiment of this disclosure provides a plurality of manners of determining different time-frequency resources, and is applicable to time-frequency resource division in different scenarios, to improve universality.

According to a second aspect, a communication method is provided, including: determining at least two time-frequency resources, where N time-frequency resources in the at least two time-frequency resources correspond to different mapping priorities, and N is a positive integer greater than or equal to 2; and sending a first signal based on the at least two time-frequency resources.

In this embodiment of this disclosure, a plurality of different time-frequency resources may correspond to different mapping priorities. Signals may be sent on different time-frequency resources based on different mapping priorities, to ensure their transmission reliability.

In a possible design, a duplex type corresponding to M time-frequency resources in the at least two time-frequency resources includes full-duplex and non-full-duplex, and a duplex type corresponding to other time-frequency resources in the at least two time-frequency resources other than the M time-frequency resources includes non-full-duplex; a duplex type corresponding to M time-frequency resources in the at least two time-frequency resources includes full-duplex, and a duplex type corresponding to other time-frequency resources in the at least two time-frequency resources other than the M time-frequency resources includes full-duplex and non-full-duplex; or a duplex type corresponding to M time-frequency resources in the at least two time-frequency resources includes full-duplex, and a duplex type corresponding to other time-frequency resources in the at least two time-frequency resources other than the M time-frequency resources includes non-full-duplex. M is a positive integer.

This embodiment of this disclosure provides a plurality of possible forms in which different time-frequency resources correspond to duplex types, so that a signal can be sent on any possible duplex type of time-frequency resource based on a mapping priority of the time-frequency resource, to ensure the transmission reliability of the signal.

In a possible design, the first signal includes at least one of the following: demodulation reference signals DMRSs and data signals.

This embodiment of this disclosure provides a plurality of possible forms of the first signal, to ensure the transmission reliability of corresponding types of signals in different scenarios.

In a possible design, densities of the DMRSs are determined based on mapping priorities corresponding to the at least two time-frequency resources.

In this embodiment of this disclosure, densities of DMRSs on time-frequency resources may be determined based on mapping priorities of different time-frequency resources, so that it is ensured that the data signals can be parsed more accurately based on the DMRSs on the time-frequency resources.

In a possible design, a sequence of mapping the data signals to the at least two time-frequency resources is determined based on the mapping priorities corresponding to the at least two time-frequency resources.

In this embodiment of this disclosure, a sequence of mapping the data signals to different time-frequency resources may be determined based on the mapping priorities, to ensure the transmission reliability of the data signals.

In a possible design, the data signals have data priorities. A sequence of mapping the data signals to the at least two time-frequency resources is determined based on the data priorities and the mapping priorities corresponding to the at least two time-frequency resources.

In this embodiment of this disclosure, different types of data signals may have different data priorities. The sequence of mapping different data signals may be determined based on different data priorities, to ensure the transmission reliability of different types of data signals on different time-frequency resources.

In a possible design, the at least two time-frequency resources are obtained in at least one of the following manners: determining the at least two time-frequency resources based on a channel measurement result and at least one measurement result threshold; and obtaining the at least two time-frequency resources in a protocol-predefined manner.

This embodiment of this disclosure provides a plurality of manners of determining different time-frequency resources, and is applicable to time-frequency resource division in different scenarios, to improve universality.

In a possible design, the method further includes: sending or receiving indication information indicating the at least two time-frequency resources.

In this embodiment of this disclosure, different time-frequency resources may be indicated by using the indication information, so that a plurality of time-frequency resources can be allocated more flexibly.

According to a third aspect, a communication apparatus is provided, including: a processing unit, configured to determine a first time-frequency resource and a second time-frequency resource, where a duplex type corresponding to the first time-frequency resource is non-full-duplex, a duplex type corresponding to the second time-frequency resource is full-duplex, and the first time-frequency resource and the second time-frequency resource correspond to different mapping priorities; and a communication unit, configured to send a first signal based on the first time-frequency resource and the second time-frequency resource.

In this embodiment of this disclosure, different time-frequency resources may correspond to different mapping priorities. Different time-frequency resources may be used to send data based on different mapping priorities, to ensure the transmission reliability of a signal.

In a possible design, the first signal includes at least one of the following: demodulation reference signals DMRSs and data signals.

In a possible design, that the first time-frequency resource and the second time-frequency resource have different mapping priorities is represented in at least one of the following manners: The DMRSs are mapped to the first time-frequency resource in a first mapping manner, the DMRSs are mapped to the second time-frequency resource in a second mapping manner, and a mapping priority corresponding to the first mapping manner is different from a mapping priority corresponding to the second mapping manner; and a mapping priority of the data signals mapped to the first time-frequency resource is different from a mapping priority of the data signals mapped to the second time-frequency resource.

In a possible design, that the mapping priority corresponding to the first mapping manner is different from the mapping priority corresponding to the second mapping manner is represented in at least one of the following manners: A density of a resource occupied by the DMRSs on the first time-frequency resource is lower than a density of a resource occupied by the DMRSs on the second time-frequency resource; time domain densities of the DMRSs on different time-frequency resources are the same, and a frequency domain density of the DMRSs on the first time-frequency resource is lower than a frequency domain density of the DMRSs on the second time-frequency resource; frequency domain densities of the DMRSs on different time-frequency resources are the same, and a time domain density of the DMRSs mapped to the first time-frequency resource is lower than a time domain density of the DMRSs on the second time-frequency resource; or a frequency domain density of the DMRSs on the first time-frequency resource is lower than a frequency domain density of the DMRSs on the second time-frequency resource, and a time domain density of the DMRSs on the first time-frequency resource is lower than a time domain density of the DMRSs on the second time-frequency resource.

In a possible design, the communication unit is further configured to send or receive first information. The first information is used to determine at least two mapping manners corresponding to the DMRSs. The at least two mapping manners corresponding to the DMRSs include the first mapping manner and the second mapping manner, and different duplex types correspond to different mapping manners.

In a possible design, the first information may be carried in one or more of the following: a protocol predefinition, a network configuration, higher layer signaling, or physical layer signaling.

In a possible design, the mapping manner corresponding to the duplex type is predefined in a protocol; the first information further indicates the duplex type corresponding to the mapping manner; or the method further includes: sending or receiving second information, where the second information further indicates the duplex type corresponding to the mapping manner.

In a possible design, the second information may be carried in one or both of the following: higher layer signaling or physical layer signaling.

In a possible design, the first signal includes the DMRSs, and the DMRSs include first DMRSs and second DMRSs. The communication unit is further configured to send or receive third information, where the third information is used to determine a mapping manner corresponding to the first DMRSs, and the first DMRSs are mapped to the first time-frequency resource and the second time-frequency resource; and sending or receiving fourth information, where the fourth information is used to determine a mapping manner corresponding to the second DMRSs, and the second DMRSs are mapped to the second time-frequency resource.

In a possible design, the third information may be carried in one or more of the following: a protocol predefinition, a network configuration, higher layer signaling, or physical layer signaling.

In a possible design, the fourth information may be carried in one or more of the following: a protocol predefinition, a network configuration, higher layer signaling, or physical layer signaling.

In a possible design, the processing unit is further configured to perform rate matching or puncturing on a time-frequency resource symmetric to the second DMRSs.

In a possible design, the first signal includes the DMRSs, and the communication unit sends or receives fifth information. The fifth information is used to determine a mapping manner corresponding to the DMRSs. A density of a resource occupied by the DMRSs is a first value. The mapping manner corresponding to the DMRSs is represented in the following manner: A density of a resource occupied by the DMRSs on the second time-frequency resource is higher than a density of a resource occupied by the DMRSs on the first time-frequency resource.

In a possible design, the fifth information may be carried in one or more of the following: a protocol predefinition, a network configuration, higher layer signaling, or physical layer signaling.

In a possible design, the first signal includes the data signals, and the data signals are sequentially mapped to the first time-frequency resource and the second time-frequency resource.

In a possible design, the data signals include first-type data signals and second-type data signals, a data priority of the first-type data signals is different from a data priority of the second-type data signals, and an order in which different data signals are sequentially mapped to the first time-frequency resource and the second time-frequency resource is determined based on the data priorities.

In a possible design, the first signal includes the data signals. Sending the data signals based on the first time-frequency resource and the second time-frequency resource meets at least one of the following: A quantity of retransmissions corresponding to the data signals transmitted on the second time-frequency resource is greater than a quantity of retransmissions corresponding to the data signals transmitted on the first time-frequency resource; an MCS for transmitting the data signals on the second time-frequency resource is lower than an MCS for transmitting the data signals on the first time-frequency resource; and a quantity of layers for transmitting the data signals on the second time-frequency resource is less than a quantity of layers for transmitting the data signals on the first time-frequency resource.

In a possible design, the different time-frequency resources are determined in any one of the following manners: predefined in a protocol; or determined through division based on a channel measurement result.

According to a fourth aspect, a communication apparatus is provided, including a processing unit, configured to determine at least two time-frequency resources, where N time-frequency resources in the at least two time-frequency resources correspond to different mapping priorities, and N is a positive integer greater than or equal to 2; and a communication unit, configured to send a first signal based on the at least two time-frequency resources.

In this embodiment of this disclosure, different time-frequency resources may correspond to different mapping priorities. Different time-frequency resources may be used to send data based on different mapping priorities, to ensure the transmission reliability of a signal.

In a possible design, a duplex type corresponding to M time-frequency resources in the at least two time-frequency resources includes full-duplex and non-full-duplex, and a duplex type corresponding to other time-frequency resources in the at least two time-frequency resources other than the M time-frequency resources includes non-full-duplex; a duplex type corresponding to M time-frequency resources in the at least two time-frequency resources includes full-duplex, and a duplex type corresponding to other time-frequency resources in the at least two time-frequency resources other than the M time-frequency resources includes full-duplex and non-full-duplex; or a duplex type corresponding to M time-frequency resources in the at least two time-frequency resources includes full-duplex, and a duplex type corresponding to other time-frequency resources in the at least two time-frequency resources other than the M time-frequency resources includes non-full-duplex. M is a positive integer.

In a possible design, the first signal includes at least one of the following: demodulation reference signals DMRSs and data signals.

In a possible design, densities of the DMRSs are determined based on mapping priorities corresponding to the at least two time-frequency resources.

In a possible design, a sequence of mapping the data signals to the at least two time-frequency resources is determined based on the mapping priorities corresponding to the at least two time-frequency resources.

In a possible design, the data signals have data priorities. A sequence of mapping the data signals to the at least two time-frequency resources is determined based on the data priorities and the mapping priorities corresponding to the at least two time-frequency resources.

In a possible design, the at least two time-frequency resources are obtained in at least one of the following manners: determining the at least two time-frequency resources based on a channel measurement result and at least one measurement result threshold; and obtaining the at least two time-frequency resources in a protocol-predefined manner.

In a possible design, the communication unit is further configured to send or receive indication information indicating the at least two time-frequency resources.

According to a fifth aspect, a communication apparatus is provided, including at least one processor and a communication interface. The communication interface is configured to receive and/or send a signal, and the processor is configured to cause the communication method in any one of the foregoing aspects to be performed.

According to a sixth aspect, a communication apparatus is provided. The communication apparatus includes at least one processor and a memory. The memory is configured to store computer instructions. When the processor executes the instructions, the communication apparatus is caused to perform the communication method in any one of the foregoing aspects.

According to a seventh aspect, a communication apparatus is provided. The communication apparatus includes a processor, configured to support a transmit end in implementing a function in any one of the foregoing aspects.

In a possible design, the communication apparatus further includes a memory, and the memory is configured to store program instructions and data that are necessary for the transmit end.

In a possible design, the communication apparatus further includes a communication interface, configured to receive and/or send a signal.

According to an eighth aspect, a chip system is provided. The chip system includes a processor and an input/output port. The processor is configured to implement a processing function in the communication method according to any one of the foregoing aspects, and the input/output port is configured to implement receiving and sending functions in the communication method according to any one of the foregoing aspects.

In a possible design, the chip system further includes a memory, and the memory is configured to store program instructions and data that are used to implement a function in the communication method according to any one of the foregoing aspects.

The chip system may include a chip, or may include a chip and another discrete component.

According to a ninth aspect, a communication system is provided. The system includes a transmit end that performs any method in any one of the foregoing aspects and a receive end that performs any method in any one of the foregoing aspects.

According to a tenth aspect, a computer-readable storage medium is provided. The computer-readable storage medium stores computer instructions. When the computer instructions are run on a computer, the computer is caused to perform the communication method according to any design in any one of the foregoing aspects.

According to an eleventh aspect, a computer program product is provided. The computer program product includes a computer program or instructions. When the computer program or the instructions are run on a computer, the computer is caused to perform the communication method according to any design in any one of the foregoing aspects.

### BRIEF DESCRIPTION OF DRAWINGS

FIG. 1 is an example diagram of an architecture of a communication system according to an embodiment of this disclosure;

FIG. 2 is a diagram of channel division according to an embodiment of this disclosure;

FIG. 3 is a diagram of channel mapping according to an embodiment of this disclosure;

FIG. 4 is a diagram of a communication scenario according to an embodiment of this disclosure;

FIG. 5 is a diagram of another communication scenario according to an embodiment of this disclosure;

FIG. 6 is a diagram of another communication scenario according to an embodiment of this disclosure;

FIG. 7 is a diagram of another communication scenario according to an embodiment of this disclosure;

FIG. 8 is a diagram of another communication scenario according to an embodiment of this disclosure;

FIG. 9 is a flowchart of a communication method according to an embodiment of this disclosure;

FIG. 10 is a diagram of resource mapping according to an embodiment of this disclosure;

FIG. 11 is a diagram of another resource mapping according to an embodiment of this disclosure;

FIG. 12 is a diagram of another resource mapping according to an embodiment of this disclosure;

FIG. 13 is a diagram of another resource mapping according to an embodiment of this disclosure;

FIG. 14 is a diagram of another resource mapping according to an embodiment of this disclosure;

FIG. 15 is a diagram of another resource mapping according to an embodiment of this disclosure;

FIG. 16 is a flowchart of another communication method according to an embodiment of this disclosure;

FIG. 17 is a diagram of time-frequency resource division according to an embodiment of this disclosure;

FIG. 18 is a diagram of a communication apparatus according to an embodiment of this disclosure; and

FIG. 19 is a diagram of another communication apparatus according to an embodiment of this disclosure.

### DESCRIPTION OF EMBODIMENTS

A network architecture and a service scenario described in embodiments of this disclosure are intended to describe the technical solutions in embodiments of this disclosure more clearly, and do not constitute a limitation on the technical solutions provided in embodiments of this disclosure. A person of ordinary skill in the art may know that: With the evolution of the network architecture and the emergence of new service scenarios, the technical solutions provided in embodiments of this disclosure are also applicable to similar technical problems.

In the specification and accompanying drawings of embodiments of this disclosure, terms such as “first” and “second” are intended to distinguish between different objects or distinguish between different processing on a same object. The words such as “first” and “second” may be used to distinguish between same items or similar items that have basically same functions and purposes. For example, a first device and a second device are merely intended to distinguish between different devices, and do not limit a sequence thereof. A person skilled in the art may understand that the words such as “first” and “second” do not limit a quantity and an execution sequence, and the words such as “first” and “second” do not indicate a definite difference.

“At least one” means one or more, and “a plurality of” means two or more.

In descriptions in embodiments of this disclosure, unless otherwise specified, “/” means an “or” relationship between associated objects. For example, A/B may represent A or B. The term “and/or” in embodiments of this disclosure describes only an association relationship between associated objects and indicates that three relationships may exist. For example, A and/or B may represent three cases: Only A exists, both A and B exist, and only B exists, where A and B may be singular or plural.

In the descriptions in embodiments of this disclosure, unless otherwise specified, “a plurality of” means two or more than two. “At least one of the following items (pieces)” or a similar expression thereof means any combination of these items, including any combination of single items (pieces) or plural items (pieces). For example, at least one item (piece) of a, b, or c may indicate: a, b, c, a and b, a and c, b and c, or a, b, and c, where a, b, and c may be singular or plural.

In addition, to clearly describe the technical solutions in embodiments of this disclosure, the words such as “first” and “second” are used in embodiments of this disclosure to distinguish between same items or similar items that have basically same functions and purposes. A person skilled in the art may understand that the words such as “first” and “second” do not limit a quantity and an execution sequence, and the words such as “first” and “second” do not indicate a definite difference.

In addition, the terms “include”, “have”, and any variant thereof mentioned in the descriptions in embodiments of this disclosure are intended to cover a non-exclusive inclusion. For example, a process, a method, a system, a product, or a device that includes a series of steps or units is not limited to the listed steps or units, but optionally further includes another unlisted step or unit, or optionally further includes another inherent step or unit of the process, the method, the product, or the device.

In embodiments of this disclosure, a word such as “example” or “for example” is used to represent giving an example, an illustration, or a description. Any embodiment or design scheme described as an “example” or “for example” in embodiments of this disclosure should not be explained as being more preferred or having more advantages than another embodiment or design scheme. Specifically, use of the word such as “example” or “for example” is intended to present a related concept in a specific manner for ease of understanding.

It may be understood that an “embodiment” mentioned in the entire specification means that particular features, structures, or features related to the embodiment are included in at least one of embodiments of this disclosure. Therefore, embodiments in the entire specification are not necessarily a same embodiment. In addition, these particular features, structures, or features may be combined in one or more embodiments in any proper manner. It may be understood that sequence numbers of the processes do not mean execution sequences in various embodiments of embodiments of this disclosure. The execution sequences of the processes should be determined based on functions and internal logic of the processes, and should not be construed as any limitation on the implementation processes of embodiments of this disclosure.

It may be understood that, in embodiments of this disclosure, both “when” and “if” mean that corresponding processing is performed in an objective situation, are not intended to limit time, do not require a determining action during implementation, and do not mean any other limitation.

It may be understood that, in some scenarios, some optional features in embodiments of this disclosure may be independently implemented without depending on another feature, for example, a solution on which the optional features are currently based, to resolve a corresponding technical problem and achieve a corresponding effect. Alternatively, in some scenarios, the optional features are combined with other features based on requirements. Correspondingly, an apparatus provided in embodiments of this disclosure may also correspondingly implement these features or functions. Details are not described herein.

In embodiments of this disclosure, unless otherwise specified, for same or similar parts of embodiments, refer to each other. In embodiments of embodiments of this disclosure and the implementations/methods/implementation methods in embodiments, unless otherwise specified or unless a logic conflict occurs, terms and/or descriptions are consistent and may be mutually referenced between different embodiments and between the implementations/methods/implementation methods in embodiments. Technical features in the different embodiments and the implementations/methods/implementation methods in embodiments may be combined to form a new embodiment, implementation, method, or implementation method based on an internal logic relationship thereof. The following implementations of embodiments of this disclosure do not constitute a limitation on the protection scope of embodiments of this disclosure.

Collection, storage, use, processing, transmission, provision, disclosure, and the like of personal user information in the technical solutions of embodiments of this disclosure all comply with related laws and regulations, and do not violate public order and good morals. For example, in the technical solutions in embodiments of this disclosure, the personal user information is processed with user authorization. Unified descriptions are provided herein. Details are not described below again.

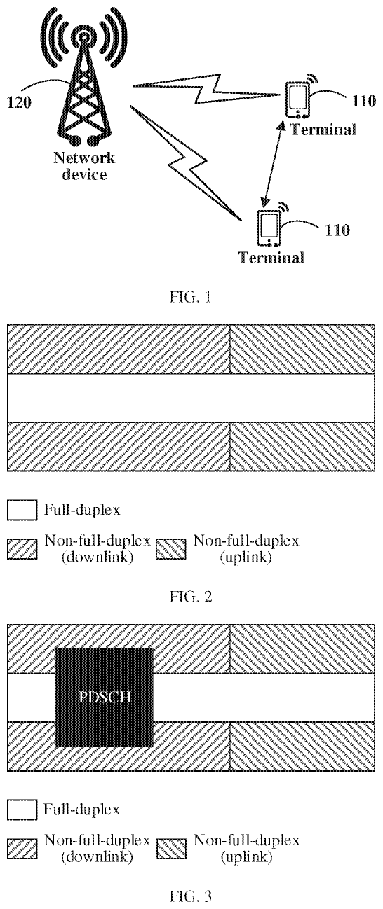

FIG. 1 is an example diagram of an architecture of a communication system according to an embodiment of this disclosure.

As shown in FIG. 1, the communication system in this embodiment of this disclosure may include at least one terminal 110 and a network device 120.

The terminal 110 communicates with the network device 120 in a wireless manner. The network device 120 may be a radio access network device. Terminals may be connected to each other in a wired or wireless manner, and radio access network devices may be connected to each other in a wired or wireless manner. FIG. 1 is merely a diagram. The communication system may further include another network device. For example, the communication system may further include a wireless relay device, a wireless backhaul device, and a core network device, which are not shown in FIG. 1. A connection relationship between devices is not limited to the foregoing enumerated manners.

The radio access network device may be a base station, an evolved NodeB (eNodeB), a transmission reception point (TRP), a next generation base station (gNodeB/gNB) in a 5G mobile communication system, a next generation base station in a 6th generation (6G) mobile communication system, a base station in a future mobile communication system, an access node in a Wi-Fi system, or the like; or may be a module or a unit that completes a part of functions of a base station, for example, may be a central unit (CU) or a distributed unit (DU). The radio access network device may be a macro base station, a micro base station, or an indoor station, or may be a relay node, a donor node, or the like. In some other embodiments, the radio access network device may alternatively be an access network device in an open RAN (O-RAN). In the O-RAN, a CU may be referred to as an open CU (O-CU), a DU may be referred to as an open DU (O-DU), and an RU may be referred to as an open RU (O-RU). A specific technology and a specific device form that are used by the radio access network device are not limited in embodiments of this disclosure. The radio access network device is sometimes referred to as a network device for short. For ease of description, the following provides descriptions by using an example in which the radio access network device is a base station.

The terminal may also be referred to as a terminal device, user equipment (UE), a mobile station, a mobile terminal, or the like. The terminal device may be widely used in various scenarios, for example, device-to-device (D2D), vehicle-to-everything (V2X) communication, machine-type communication (MTC), an internet of things (IOT), virtual reality, augmented reality, industrial control, self-driving, telemedicine, a smart grid, smart furniture, a smart office, a smart wearable, smart transportation, and a smart city. The terminal device may be a mobile phone, a tablet computer, a computer having a wireless transceiver function, a wearable device, a vehicle, an uncrewed aerial vehicle, a helicopter, an airplane, a ship, a robot, a robotic arm, a smart home device, or the like. A specific technology and a specific device form used by the terminal device are not limited in embodiments of this disclosure.

The base station and the terminal may be fixed or movable. The base station and the terminal device may be deployed on land, including an indoor or outdoor device, a handheld device, or a vehicle-mounted device; may be deployed on a water surface; or may be deployed on an airplane, a balloon, or an artificial satellite in the air. Application scenarios of the base station and the terminal device are not limited in embodiments of this disclosure.

Communication between the base station and the terminal, between the base stations, or between the terminals may be performed by using a licensed spectrum, may be performed by using an unlicensed spectrum, or may be performed by using both a licensed spectrum and an unlicensed spectrum. Communication may be performed by using a spectrum below 6 gigahertz (GHz), may be performed by using a spectrum above 6 GHz, or may be performed by using both a spectrum below 6 GHz and a spectrum above 6 GHz. A spectrum resource used for wireless communication is not limited in embodiments of this disclosure.

In embodiments of this disclosure, a function of the base station may alternatively be performed by a module (for example, a chip) in the base station, or may be performed by a control subsystem including the function of the base station. The control subsystem including the function of the base station herein may be a control center in an application scenario of the foregoing terminal device, for example, the smart grid, the industrial control, the smart transportation, or the smart city. A function of a repeater may alternatively be performed by a module (for example, a chip or a modem) in the repeater, or may be performed by an apparatus including a relay function. A function of the terminal may alternatively be performed by a module (for example, a chip or a modem) in the terminal, or may be performed by an apparatus including the function of the terminal.

A wireless communication system includes communication devices, and the communication devices may perform wireless communication by using an air interface resource. The communication devices may include a network device and a terminal device, and the network device may also be referred to as a base station device. The air interface resource may include at least one of a time domain resource, a frequency domain resource, a code resource, and a spatial resource. The communication device may also be referred to as a communication apparatus.

The solutions provided in embodiments of this disclosure may be applied to wireless communication between the communication devices. The wireless communication may include: wireless communication between the network device and the terminal, wireless communication between network devices, and wireless communication between the terminals. In embodiments of this disclosure, the term “wireless communication” may also be briefly referred to as “communication”, and the term “communication” may also be described as “data transmission”, “information transmission”, or “transmission”.

Embodiments of this disclosure may be applied to possible communication links such as an uplink (UL), a downlink (DL), an access link, a backhaul link, and a sidelink (SL). This is not limited in embodiments of this disclosure. From a perspective of a service scenario, embodiments of this disclosure are applicable to a plurality of scenarios, for example, an extended reality (XR) service, an artificial intelligence (AI) service, and a large-capacity scenario. This is not limited in embodiments of this disclosure. The SL may also be referred to as a sidelink link, a sidelink, or the like. This is not limited in embodiments of this disclosure.

Currently, a most significant feature of a URLLC scenario is a low latency and high reliability. In addition, the URLLC scenario is also widely used, and different scenarios, for example, a power automation “telemetry, remote communication, and remote control” scenario, an internet of vehicles scenario, and an industrial manufacturing scenario, have different requirements for latency, reliability, and bandwidth.

Compared with subband full-duplex (SBFD), bandwidth part-full-duplex (BWP-FD) may support full-duplex in any subband. The BWP-FD may adjust a duplex mode based on a service requirement, to flexibly match the service requirements and latency requirements. Compared with the SBFD, the BWP-FD has an advantage of increasing uplink bandwidth without causing a downlink bandwidth loss, and is applicable to the URLLC scenario.

For example, FIG. 2 shows a possible frequency band division manner. Refer to FIG. 2. Some frame structures may include a full-duplex area and a non-full-duplex area. For example, a subband corresponding to a white area in the figure may be full-duplex (FD), and a subband corresponding to an area filled with oblique lines may be non-full-duplex (non FD). In some examples, the non-full-duplex may also be referred to as half-duplex. The non-full-duplex area, for example, an oblique line area in different directions in FIG. 2, may be used for uplink or downlink based on a situation. For example, an oblique line area from the upper right to the lower left may be used for downlink, and an oblique line area from the upper left to the lower right may be used for uplink. Certainly, the non-full-duplex area may be randomly adjusted to be used for uplink or downlink based on an actual situation. FIG. 2 is merely a possible example. This is not limited in embodiments of this disclosure.

The full-duplex area may also be referred to as a full-duplex time-frequency resource. A signal on this type of time-frequency resource may be simultaneously sent in both directions of one communication link, that is, it may be considered that there are two channels. Both a transmit end and a receive end of the communication link have an independent signal receiving capability and an independent signal sending capability. For example, the full-duplex area may be simultaneously used for uplink and downlink or transmission in both directions of a same communication link.

The non-full-duplex area may also be referred to as a half-duplex area, a non-full-duplex time-frequency resource, a half-duplex time-frequency resource, or the like. A signal on this type of time-frequency resource may be sent in both directions of one communication link, but is allowed to be sent in only one direction at a same time. Both a transmit end and a receive end of the communication link have an independent signal receiving capability and an independent signal sending capability. However, the transmit end and the receive end cannot simultaneously send or receive a signal. For example, the non-full-duplex area may be separately used for uplink and downlink or transmission in a specific direction of a same communication link based on different time.

Embodiments of this disclosure may be applied to a BWP-FD scenario, a scenario in which the non-full-duplex and the full-duplex are included in any time period, and the like. This is not limited in embodiments of this disclosure.

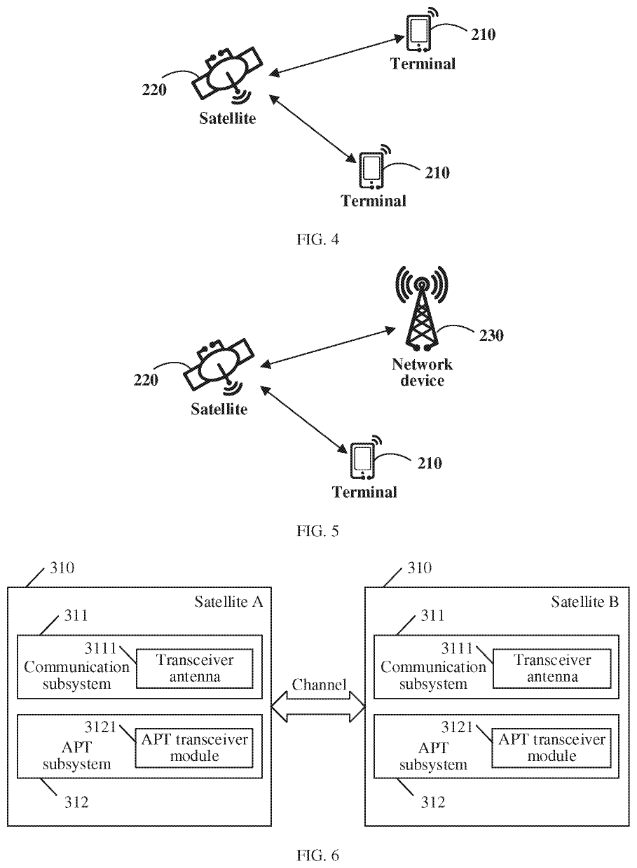

However, it is considered that data of some services related to a low latency and high reliability may be simultaneously mapped to the full-duplex area and the non-full-duplex area. For example, as shown in FIG. 3, it can be learned that a physical downlink shared channel (PDSCH) is simultaneously mapped to the full-duplex area and the non-full-duplex area. However, for the full-duplex area, there is very severe interference when uplink communication and downlink communication simultaneously exist. In other words, a channel environment on this part of time-frequency resources is very poor. It may be understood that FIG. 3 shows only a case of the PDSCH, and is also applicable to another uplink channel or downlink channel. If a current signal mapping manner is used, reliability of a signal communication process cannot be met due to severe interference in some areas.

Therefore, this disclosure provides a communication method. Different time-frequency resources may correspond to different mapping priorities, to improve the transmission reliability of signals.

Embodiments of this disclosure are applicable to a plurality of communication scenarios. The following describes possible scenarios to which embodiments of this disclosure are applicable.

FIG. 4 is a diagram of a communication scenario according to an embodiment of this disclosure.

As shown in FIG. 4, this embodiment of this disclosure is applicable to a communication scenario like satellite communication. The scenario may include a satellite 220 and a terminal 210. The terminal 210 may be a network element of a terminal type, for example, may be the terminal 110 in FIG. 1. The satellite 220 may provide a communication service for the terminal 210. The satellite 220 sends downlink data to the terminal 210, where the downlink data may be encoded by using a channel coding technology. Then, encoded data is sent to the terminal 210 through constellation modulation. The terminal 210 may send uplink data to the satellite 220, where the uplink data may also be encoded by using the channel coding technology. Then, encoded data is sent to the satellite 220 through constellation modulation.

For another example, FIG. 5 is a diagram of another communication scenario according to an embodiment of this disclosure. FIG. 5 is similar to FIG. 4, and a difference lies in that the satellite 220 may alternatively communicate with a network device 230. The network device 230 may be similar to the network device 120 shown in FIG. 1. When the satellite 220 in FIG. 5 communicates with the terminal 210, the satellite 220 may be considered as a network device. When the satellite 220 communicates with the network device 230, the satellite 220 may be considered as a terminal.

In some examples, the satellite 220 may be an uncrewed aerial vehicle, a hot air balloon, a low earth orbit satellite, a medium earth orbit satellite, a high earth orbit satellite, or the like, or may be a non-terrestrial base station, a non-terrestrial device, or the like. This is not limited in embodiments of this disclosure.

FIG. 6 is a diagram of another communication scenario according to an embodiment of this disclosure.

As shown in FIG. 6, this scenario may represent inter-satellite communication between satellites. A satellite 310 may be a satellite A or a satellite B. The satellite 310 may be the same as the satellite 220 in FIG. 4 and FIG. 5. The satellite 310 may include a communication subsystem 311, and an acquisition, positioning and tracking (APT) subsystem 312 that are independent of each other. The communication subsystem 311 is responsible for inter-satellite information exchange, and may be considered as a body of an inter-satellite communication system. The APT subsystem 312 is responsible for acquisition, positioning, and tracking between the satellites. The acquisition may be determining a direction of arrival of an incident signal. The positioning may be adjusting a transmit beam to aim at a receiving direction. The tracking may be considered as continuously adjusting the positioning and acquisition in an entire communication process. The communication subsystem 311 may include a transceiver antenna 3111, and the APT subsystem 312 may include an APT transceiver module 3121.

For the inter-satellite communication system, to minimize impact of attenuation and interference on a channel, both high confidentiality and a high transmission rate are required. The APT needs to be adjusted in real time to continuously adapt to possible environmental changes. Currently, the APT subsystem 312 is usually an optical system, in which optical positioning is difficult, and a direction usually needs to be mechanically adjusted. Currently, most of communication subsystems 311 are also optical communication systems, and there are also some microwave band communication systems. Most of the communication subsystems 311 use a single high-gain antenna.

In some embodiments, embodiments of this disclosure are applicable to the cellular communication scenario shown in FIG. 1. A cellular communication system may usually include a plurality of cells. Each cell may include one base station (BS). The base station may provide services for a plurality of mobile stations (MSs). The base station may include a baseband unit (BBU) and a remote radio unit (RRU). The BBU and the RRU may be disposed at different places. For example, the RRU is disposed in a heavy-traffic area, and the BBU is disposed in a central equipment room. Certainly, the BBU and the RRU may alternatively be disposed in a same equipment room. Alternatively, the BBU and the RRU may be different components in one rack.

In some examples, the communication scenario shown in FIG. 1 is applicable to, but is not limited to, a narrowband-internet of things (NB-IoT) system, a global system for mobile communications (GSM), an enhanced data rate for global system for mobile communications evolution (EDGE), a wideband code division multiple access (WCDMA) system, a code division multiple access 2000 (CDMA2000) system, a time division-synchronization code division multiple access (TD-SCDMA) system, a long term evolution (LTE) system, three major application scenarios of a next generation mobile communication system: enhanced mobile broadband (eMBB), URLLC, enhanced machine-type communication (eMTC), and the like.

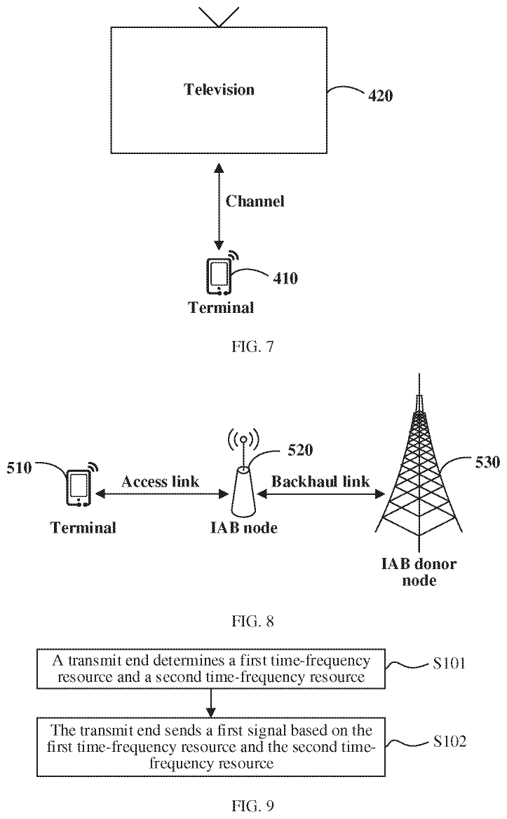

FIG. 7 is a diagram of another communication scenario according to an embodiment of this disclosure.

The scenario shown in FIG. 7 may include a terminal 410 and a television 420. The terminal 410 may be similar to the terminal 110 in FIG. 1, and the terminal 210 in FIG. 4 and FIG. 5. The scenario shown in FIG. 7 may be considered as a scenario in which the terminal 410 performs wireless projection, a virtual reality (VR) game, and the like by using the television 420.

FIG. 8 is a diagram of another communication scenario according to an embodiment of this disclosure.

The communication scenario shown in FIG. 8 may be an integrated access and backhaul (IAB) communication scenario. For example, the IAB communication scenario may include a terminal 510, an IAB node 520, and an IAB donor node 530. The IAB donor node may also be referred to as an IAB parent node. The terminal 510 is similar to the terminal 110 in FIG. 1, the terminal 210 in FIG. 4 and FIG. 5, and the terminal 410 in FIG. 7. A communication link between the terminal 510 and the IAB node may be referred to as an access link (AL), and a communication link between the IAB node 520 and the IAB donor node 530 may be referred to as a backhaul link (BL).

It may be understood that embodiments of this disclosure are applicable to any scenario mentioned above, and certainly another possible communication scenario may be further included. This is not limited in embodiments of this disclosure.

FIG. 9 is a flowchart of a communication method according to an embodiment of this disclosure.

As shown in FIG. 9, this communication process is applicable to, but is not limited to, the communication scenarios shown in FIG. 1 and FIG. 4 to FIG. 8. The method may be applied to a transmit end. The transmit end may be various possible devices in the foregoing scenarios, such as the terminal, the network device, the satellite, the IAB node, and the IAB donor node. This is not limited in embodiments of this disclosure. The method may include the following steps.

S101: The transmit end determines a first time-frequency resource and a second time-frequency resource.

In some embodiments, the transmit end may determine the first time-frequency resource and the second time-frequency resource. The first time-frequency resource and the second time-frequency resource correspond to different mapping priorities. In some examples, a duplex type corresponding to the first time-frequency resource may be non-full-duplex, and a duplex type corresponding to the second time-frequency resource may be full-duplex.

In some examples, the first time-frequency resource and the second time-frequency resource may be time-frequency resources corresponding to a first channel. The first channel may be considered as a communication channel used to send a first signal. The first signal is a signal to be sent by the transmit end. For example, the first signal may be mapped to the first time-frequency resource and the second time-frequency resource that correspond to the first channel.

In some embodiments, the first signal may be demodulation reference signals (DMRS).

In some embodiments, the first signal may be data signals.

In some embodiments, the first signal may be DMRSs and data signals.

This embodiment of this disclosure provides a plurality of possible forms of the first signal, to ensure the transmission reliability of corresponding types of signals in different scenarios.

S102: The transmit end sends the first signal based on the first time-frequency resource and the second time-frequency resource.

In some embodiments, the transmit end may send the first signal based on the first time-frequency resource and the second time-frequency resource that are determined in S101.

For example, the transmit end may map the first signal to the first time-frequency resource and the second time-frequency resource. The transmit end may send a mapped first signal to a receive end based on the first time-frequency resource and the second time-frequency resource. The receive end is a device that receives the first signal. For example, the receive end may be any possible device in the communication scenarios shown in FIG. 1 and FIG. 4 to FIG. 8, such as the terminal, the network device, the satellite, the IAB node, or the IAB donor node. This is not limited in embodiments of this disclosure.

In some examples, a first signal may be mapped to a part or all of resources in the first time-frequency resource, and may be mapped to a part or all of resources in the second time-frequency resource. For example, the first signal may be mapped to a part of resources in the first time-frequency resource and a part of resources in the second time-frequency resource; the first signal may be mapped to a part of resources in the first time-frequency resource and all resources in the second time-frequency resource; the first signal may be mapped to all resources in the first time-frequency resource and a part of resources in the second time-frequency resource; or the first signal may be mapped to all resources in the first time-frequency resource and all resources in the second time-frequency resource.

In embodiments of this disclosure, a full-duplex time-frequency resource and a non-full-duplex time-frequency resource may correspond to different mapping priorities. Signals may be sent on different time-frequency resources based on different mapping priorities, to ensure their transmission reliability.

In the communication method provided in embodiments of this disclosure, different types of signals may correspond to different mapping priorities on different time-frequency resources, to ensure the transmission reliability of corresponding types of signals on different time-frequency resources. The first time-frequency resource and the second time-frequency resource are used as an example. That the first time-frequency resource and the second time-frequency resource have different mapping priorities is represented in at least one of the following manners: The DMRSs are mapped to the first time-frequency resource in a first mapping manner, the DMRSs are mapped to the second time-frequency resource in a second mapping manner, and a mapping priority corresponding to the first mapping manner is different from a mapping priority corresponding to the second mapping manner; and a mapping priority of the data signals mapped to the first time-frequency resource is different from a mapping priority of the data signals mapped to the second time-frequency resource.

In some embodiments, that the first time-frequency resource and the second time-frequency resource have different mapping priorities may be represented as follows: The DMRSs are mapped to the first time-frequency resource in the first mapping manner, and the DMRSs are mapped to the second time-frequency resource in the second mapping manner.

For example, considering that the mapping priorities of the first time-frequency resource and the second time-frequency resource are different, in a process of mapping the DMRSs to the first time-frequency resource and the second time-frequency resource, the DMRSs may be separately mapped in different mapping manners. In other words, different mapping manners may be selected based on the mapping priorities of different time-frequency resources, so that the DMRSs are mapped to the corresponding time-frequency resource in a proper mapping manner.

In some embodiments, that the first time-frequency resource and the second time-frequency resource have different mapping priorities may be represented as follows: The mapping priority of the data signals mapped to the first time-frequency resource is different from the mapping priority of the data signals mapped to the second time-frequency resource.

For example, considering that the mapping priorities of the first time-frequency resource and the second time-frequency resource are different, how to map the data signals to the first time-frequency resource and the second time-frequency resource may be determined based on the mapping priorities. For example, the data signals may be preferentially mapped to a time-frequency resource of a specific mapping priority. For another example, some types of data signals are preferentially mapped.

In some embodiments, that the first time-frequency resource and the second time-frequency resource have different mapping priorities may be represented as follows: The DMRSs are mapped to the first time-frequency resource in the first mapping manner, and the DMRSs are mapped to the second time-frequency resource in the second mapping manner; and the mapping priority of the data signals mapped to the first time-frequency resource is different from the mapping priority of the data signals mapped to the second time-frequency resource.

In embodiments of this disclosure, different types of signals may correspond to different mapping priorities on the full-duplex time-frequency resource and the non-full-duplex time-frequency resource. Therefore, different types of signals are mapped to the full-duplex time-frequency resource and the non-full-duplex time-frequency resource in corresponding mapping manners for transmission, to ensure the transmission reliability of corresponding types of signals.

In embodiments of this disclosure, mapping manners of different types of first signals are described in more detail below based on the type of the first signal.

Scenario 1: The first signal is the DMRSs.

In the communication method provided in embodiments of this disclosure, for the first signal being the DMRSs, and a density of the DMRSs mapped to the first time-frequency resource and a density of the DMRSs mapped to the second time-frequency resource may be flexibly set, to ensure that the data signals can also be parsed accurately based on the DMRSs on the time-frequency resource with more severe interference. In a possible manner, that the mapping priority corresponding to the first mapping manner of the DMRSs on the first time-frequency resource is different from the mapping priority corresponding to the second mapping manner of the DMRSs on the second time-frequency resource may be specifically represented in at least one of the following manners: A density of a resource occupied by the DMRSs on the first time-frequency resource is lower than a density of a resource occupied by the DMRSs on the second time-frequency resource; time domain densities of the DMRSs on different time-frequency resources are the same, and a frequency domain density of the DMRSs on the first time-frequency resource is lower than a frequency domain density of the DMRSs on the second time-frequency resource; frequency domain densities of the DMRSs on different time-frequency resources are the same, and a time domain density of the DMRSs mapped to the first time-frequency resource is lower than a time domain density of the DMRSs on the second time-frequency resource; or a frequency domain density of the DMRSs on the first time-frequency resource is lower than a frequency domain density of the DMRSs on the second time-frequency resource, and a time domain density of the DMRSs on the first time-frequency resource is lower than a time domain density of the DMRSs on the second time-frequency resource.

For different representation manners, embodiments of this disclosure provide more specific descriptions in different cases.

### Case 1:

In some embodiments, for the first signal being the DMRSs, that the mapping priority corresponding to the first mapping manner is different from the mapping priority corresponding to the second mapping manner may be represented as follows: The density of the resource occupied by the DMRSs on the first time-frequency resource is lower than the density of the resource occupied by the DMRSs on the second time-frequency resource. The density of the resource occupied by the DMRSs may be understood as a ratio of a quantity of resource elements (REs) occupied by the DMRSs on a specific resource to a total quantity of REs occupied by the resource. Alternatively, the density of the resource occupied by the DMRSs may be understood as a density of a time domain resource occupied by the DMRSs; may be understood as a density of a frequency domain resource occupied by the DMRSs; or may be understood as a density of a frequency domain resource occupied by the DMRSs and a density of a time domain resource occupied by the DMRSs. This is not limited in this embodiment of this disclosure.

In embodiments of this disclosure, the density of the time domain resource occupied by the DMRSs may also be referred to as a time domain density of the DMRSs, and may represent a ratio of a quantity of symbols including the DMRSs on a specific resource to a total quantity of symbols occupied by the resource. The density of the frequency domain resource occupied by the DMRSs may also be referred to as a frequency domain density of the DMRSs, and may represent a ratio of a quantity of frequency domain REs including the DMRSs on one symbol to a total quantity of REs on the symbol on a specific frequency domain resource. Certainly, the ratio may be represented in a fraction, a decimal, a percentage, or any other possible form. This is not limited in this embodiment of this disclosure.

For example, the density of the resource occupied by the DMRSs on the first time-frequency resource may be lower than the density of the resource occupied by the DMRSs on the second time-frequency resource, so that a proportion of the DMRSs on the second time-frequency resource is higher. Considering that the second time-frequency resource may be a full-duplex area, interference is severe. Therefore, a higher DMRS proportion is set, so that the receive end can better parse data transmitted on this part of resources.

### Case 2:

In some embodiments, for the first signal being the DMRSs, that the mapping priority corresponding to the first mapping manner is different from the mapping priority corresponding to the second mapping manner may be represented as follows: The time domain densities of the DMRSs on different time-frequency resources are the same, and the frequency domain density of the DMRSs on the first time-frequency resource is lower than the frequency domain density of the DMRSs on the second time-frequency resource.

In other words, the time domain densities of the DMRSs on different time-frequency resources may be the same, that is, proportions of symbols occupied by the DMRSs on different time-frequency resources are the same. For frequency domain, a higher frequency domain density may be assigned to the second time-frequency resource.

For example, the time domain density of the DMRSs on the first time-frequency resource is the same as the time domain density of the DMRSs on the second time-frequency resource. A frequency domain density of DMRSs on one or more symbols configured with the DMRSs on the second time-frequency resource may be set to ⅔; and a frequency domain density of DMRSs on one or more symbols configured with the DMRSs on the first time-frequency resource may be set to ½. For another example, on the second time-frequency resource, a frequency domain density of DMRSs on one or more symbols configured with the DMRSs may be set to ½; and a frequency domain density of DMRSs on one or more symbols configured with the DMRSs on the first time-frequency resource may be set to ⅓. In some examples, a frequency domain density of DMRSs on each symbol configured with the DMRSs on the second time-frequency resource may be higher than a frequency domain density of DMRSs on each symbol configured with the DMRSs on the first time-frequency resource. Certainly, if only a frequency domain density on a part of DMRS symbols on the second time-frequency resource is configured to be higher than a frequency domain density of DMRSs on a part of DMRS symbols on the first time-frequency resource, it needs to be ensured that an overall frequency domain density of DMRSs on the second time-frequency resource is higher than an overall frequency domain density of the DMRSs on the first time-frequency resource.

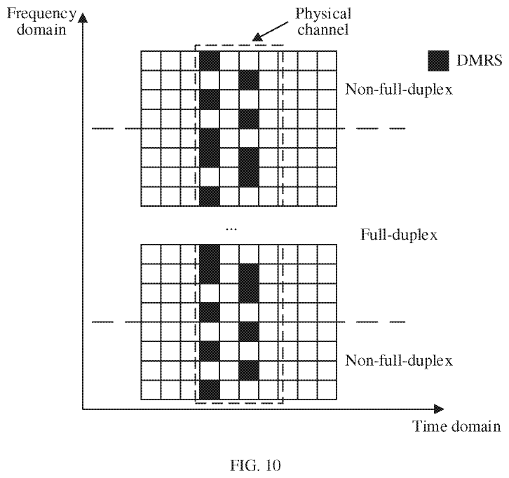

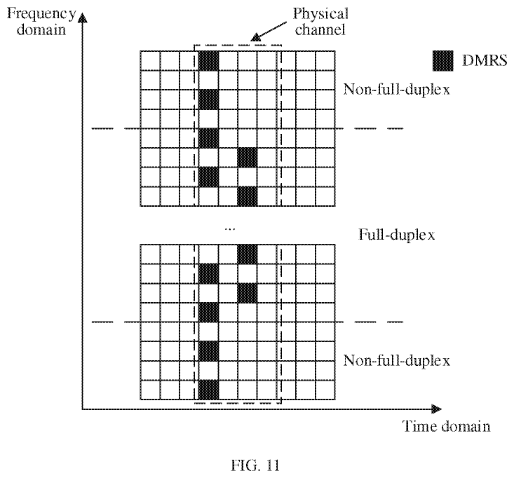

In some examples, FIG. 10 is a diagram of resource mapping. It can be learned that, symbols occupied by DMRSs on a non-full-duplex time-frequency resource are the same as symbols occupied by DMRSs on a full-duplex time-frequency resource. That is, it is ensured that time domain densities of the DMRSs on different time-frequency resources are the same. On the non-full-duplex time-frequency resource, a frequency domain density of the DMRSs is ½, that is, the DMRSs are mapped to one RE in every two REs. On the full-duplex time-frequency resource, a frequency domain density of the DMRSs is ⅔, that is, the DMRSs are mapped to two REs in every three REs. It is assumed that the first time-frequency resource is a time-frequency resource corresponding to non-full-duplex, and the second time-frequency resource is a time-frequency resource corresponding to full-duplex. It is clear that the frequency domain density of the DMRSs on the first time-frequency resource is lower than the frequency domain density of the DMRSs on the second time-frequency resource.

A physical channel in embodiments of this disclosure may represent the first channel corresponding to the to-be-sent first signal. The first channel may be a physical uplink channel, may be a physical downlink channel, or may be a physical sidelink channel. The first channel may be a control channel or a shared channel. For example, the physical channel may be a PDSCH, a physical downlink control channel (PDCCH), a physical uplink shared channel (PUSCH), a physical uplink control channel (PUCCH), a physical sidelink shared channel (PSSCH), or a physical sidelink control channel (PSCCH). For another example, the physical channel may alternatively be a physical reception link control channel (PRxCCH), a physical reception link shared channel (PRxSCH), a physical transmission link control channel (PTxCCH), a physical transmission link shared channel (PTxSCH), or the like. This is not limited herein in This disclosure.

The PRxCCH and the PTxCCH may be physical layer control channels. The PRxCCH may be a physical layer control channel received by the terminal, and the PTxCCH may be a physical layer control channel sent by the terminal. The PRxSCH and the PTxSCH may be physical layer data channels. The PRxSCH may be a physical layer data channel received by the terminal, and the PTxSCH may be a physical layer data channel sent by the terminal.

It may be understood that, considering that the second time-frequency resource may be a full-duplex area, interference is severe. When it is ensured that the time domain density of the DMRSs remains unchanged, the DMRSs are configured with different frequency domain densities on different time-frequency resources. For example, the frequency domain density of the DMRSs on the second time-frequency resource is higher than the frequency domain density of the DMRSs on the first time-frequency resource, so that the receive end can better parse data transmitted on this part of frequency bands.

### Case 3:

In some embodiments, for the first signal being the DMRSs, that the mapping priority corresponding to the first mapping manner is different from the mapping priority corresponding to the second mapping manner may be represented as follows: The frequency domain densities of the DMRSs on different time-frequency resources are the same, and the time domain density of the DMRSs mapped to the first time-frequency resource is lower than the time domain density of the DMRSs on the second time-frequency resource.

In other words, the frequency domain densities of the DMRSs on different time-frequency resources may be the same, that is, frequency domain proportions of DMRSs on symbols occupied by the DMRSs on different time-frequency resources are the same. For time domain, a higher time domain density may be assigned to the second time-frequency resource.

For example, the frequency domain density of the DMRSs on the first time-frequency resource is the same as the frequency domain density of the DMRSs on the second time-frequency resource. On the second time-frequency resource, DMRSs may be newly added to a part of symbols. The DMRSs may be newly added to the part of symbols based on different DMRS mapping types. The newly added DMRSs may be considered as additional DMRSs on the second time-frequency resource compared with the first time-frequency resource. For example, the DMRS mapping types may be classified into a mapping type A and a mapping type B. The mapping type A may be for determining a symbol based on a slot. The mapping type B may be for determining a symbol based on a physical channel.

For example, if newly added DMRSs are determined by using the mapping type A, it may be determined based on a slot that the DMRSs are newly added to a 5th symbol, a 9th symbol, and a 13^{th} symbol in the slot; it is determined that the DMRSs are newly added to a 6^{th} symbol and a 10^{th} symbol in the slot; or it is determined that the DMRSs are newly added to a 7^{th} symbol and an 11^{th} symbol in the slot.

For example, if newly added DMRSs are determined by using the mapping type B, it may be determined based on a time-frequency resource corresponding to a physical channel to be sent that the DMRSs are newly added to a 2^{nd} symbol on the time-frequency resource; it is determined that the DMRSs are newly added to a 2^{nd} symbol and a 3^{rd} symbol on the time-frequency resource; it is determined that the DMRSs are newly added to an intermediate symbol on the time-frequency resource; or it is determined that the DMRSs are newly added to a last symbol on the time-frequency resource. For the intermediate symbol on the time-frequency resource, assuming that the time-frequency resource corresponding to the physical channel occupies five symbols, a 3^{rd} symbol may be the intermediate symbol; or assuming that the time-frequency resource corresponding to the physical channel occupies 10 symbols, a 5^{th} symbol and a 6^{th} symbol may be the intermediate symbol.

It may be understood that, for the mapping type A, a symbol position of the newly added DMRSs is determined based on the slot; and for the mapping type B, a symbol position of the newly added DMRSs is determined based on the time-frequency resource corresponding to the physical channel.

In some examples, FIG. 11 is a diagram of resource mapping. Similar to FIG. 10, the time-frequency resources may be classified into the full-duplex time-frequency resource and the non-full-duplex time-frequency resource. Regardless of on the full-duplex time-frequency resource or the non-full-duplex time-frequency resource, on a 1^{st} symbol on the physical channel, a frequency domain density of DMRSs is ½, that is, the DMRSs are mapped to one RE in every two REs. On the full-duplex time-frequency resource, it can be learned that DMRSs are newly added to a 3^{rd} symbol on the physical channel. A frequency domain density of the DMRSs newly added to the symbol may also be ½. In other words, although symbol positions occupied by the DMRSs on the full-duplex time-frequency resource are more than symbol positions occupied by the DMRSs on the non-full-duplex time-frequency resource, frequency domain densities are the same.

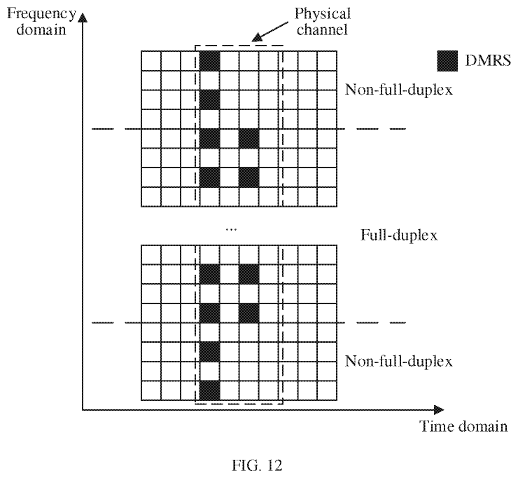

In some examples, that the frequency domain densities of the DMRSs on different time-frequency resources are the same may be that the frequency domain densities of the DMRSs are the same and frequency domain positions of the DMRSs are the same. Refer to FIG. 12. On the full-duplex time-frequency resource, frequency domain positions occupied by DMRSs on the 1^{st} symbol corresponding to the physical channel are the same as frequency domain positions occupied by DMRSs on the 3^{rd} symbol corresponding to the physical channel. In this case, the DMRSs on the 3^{rd} symbol may not need to be separately indicated.

In some examples, that the frequency domain densities of the DMRSs on different time-frequency resources are the same may be that the frequency domain densities of the DMRSs are the same and frequency domain positions of the DMRSs are different. For example, refer to FIG. 11. On the full-duplex time-frequency resource, frequency domain positions occupied by the DMRSs on the 1^{st} symbol corresponding to the physical channel are different from frequency domain positions occupied by the DMRSs on the 3^{rd} symbol corresponding to the physical channel. In this case, the DMRSs on the 3^{rd} symbol may be separately indicated. For example, a start position of the DMRSs on the 3^{rd} symbol on the physical channel corresponding to the full-duplex time-frequency resource is indicated.

It may be understood that, considering that the second time-frequency resource may be a full-duplex area, interference is severe. When it is ensured that the frequency domain density of the DMRSs remains unchanged, the DMRSs are configured with different time domain densities on different time-frequency resources. For example, the time domain density of the DMRSs on the second time-frequency resource is higher than the time domain density of the DMRSs on the first time-frequency resource, so that the receive end can better parse data transmitted on this part of frequency bands.

### Case 4:

In some embodiments, for the first signal being the DMRSs, that the mapping priority corresponding to the first mapping manner is different from the mapping priority corresponding to the second mapping manner may be represented as follows: The frequency domain density of the DMRSs on the first time-frequency resource is lower than the frequency domain density of the DMRSs on the second time-frequency resource, and the time domain density of the DMRSs on the first time-frequency resource is lower than the time domain density of the DMRSs on the second time-frequency resource.

In other words, for frequency domain, a higher frequency domain density may be assigned to the second time-frequency resource. For time domain, a higher time domain density may be assigned to the second time-frequency resource.

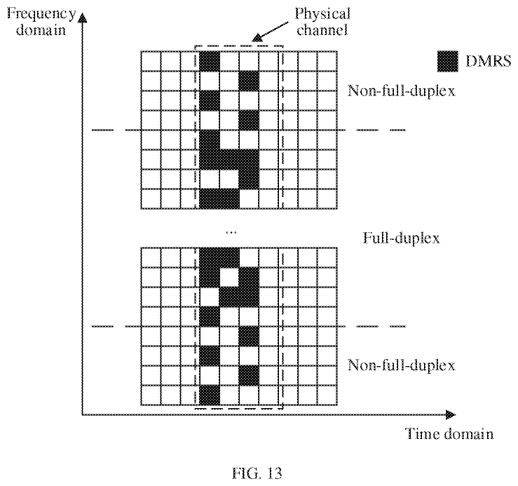

A solution in FIG. 13 is equivalent to a combination of the solutions in FIG. 10 and FIG. 11. A higher frequency domain density of DMRSs, for example, ⅔, may be assigned to the full-duplex time-frequency resource. A low frequency domain density of DMRSs, for example, ½, may be assigned to the non-full-duplex time-frequency resource. In addition, the DMRSs may occupy more symbols on the full-duplex time-frequency resource, for example, occupy a 1^{st} symbol, a 2^{nd} symbol, and a 3^{rd} symbol that correspond to a physical channel. However, the DMRSs may occupy a small quantity of symbols on the non-full-duplex time-frequency resource, for example, occupy the 1^{st} symbol and the 3^{rd} symbol that correspond to a physical channel. For details, refer to related descriptions in FIG. 10 and FIG. 11. Details are not described herein again in this embodiment of this disclosure.

It should be noted that, in embodiments of this disclosure, the DMRS may be a single-symbol DMRS, or may be a double-symbol DMRS. A DMRS symbol type, for example, a single-symbol type or a double-symbol type, may be configured when the DMRS mapping manner is configured.

This embodiment of this disclosure provides a plurality of manners of mapping the DMRSs to different time-frequency resources. The DMRS density configured for the full-duplex time-frequency resource is higher than the DMRS density configured for the non-full-duplex time-frequency resource, so that proper DMRS densities are used to perform sending on corresponding time-frequency resources in different scenarios. This improves reliability of parsing the data signals based on the DMRSs on the full-duplex time-frequency resource and the non-full-duplex time-frequency resource.

In the communication method provided in embodiments of this disclosure, a plurality of DMRS mapping manners may be configured by using first information, so that the DMRSs can be mapped to different time-frequency resources in proper mapping manners. For example, the method may further include: The transmit end sends or receives first information, where the first information is used to determine at least two mapping manners corresponding to the DMRSs. The at least two mapping manners corresponding to the DMRSs include the first mapping manner and the second mapping manner, and different duplex types correspond to different mapping manners.

For example, if the transmit end is the network device, the transmit end may generate the first information. The transmit end may send the first information to the terminal, to configure a DMRS mapping manner used by the terminal. For another example, if the transmit end is the terminal, the transmit end may receive the first information, for example, receive the first information sent by the network device. The transmit end may determine, based on the first information, mapping manners used to send the DMRSs. The transmit end may map the DMRSs to the first time-frequency resource and the second time-frequency resource in the mapping manners, and send the DMRSs. It may be understood that the transmit end in embodiments of this disclosure is a device or an apparatus that sends the first signal.

In some examples, the first information may be higher layer signaling, for example, may be radio resource control (RRC) signaling or a media access control control element (MAC CE).

In some examples, the first information may include a DMRS mapping manner corresponding to full-duplex and a DMRS mapping manner corresponding to non-full-duplex. Certainly, in some examples, the first information may further include a DMRS mapping manner corresponding to a guard band.

In some examples, the at least two mapping manners corresponding to the DMRSs may be indicated in the first information in a form of a DMRS parameter. Each DMRS parameter may correspond to one DMRS mapping manner. For example, different DMRS parameters may be configured in one piece of first information. In other words, a plurality of DMRS parameters are configured by using one piece of higher layer signaling. In other words, the at least two mapping manners corresponding to the DMRSs are configured. For another example, different DMRS parameters may be configured by using different first information. In other words, each DMRS parameter is configured by using independent higher layer signaling.

In some embodiments, the first information may be carried in one or more of the following: a protocol predefinition, a network configuration, higher layer signaling, or physical layer signaling.

For example, the first information is predefined in a protocol. For another example, the first information may be configured by the network device. For still another example, the first information may be carried in the higher layer signaling. For example, the first information is carried in RRC or a MAC CE. For still another example, the first information may be carried in the physical layer signaling. For example, the first information is carried in downlink control information (DCI), uplink control information (UCI), or sidelink control information (SCI). For still another example, the first information may be configured by the network device, and may be carried in the higher layer signaling. It may be understood that the first information may be carried or configured in any one or more of the foregoing manners. This is not enumerated herein in this embodiment of this disclosure.

The DCI, the UCI, and the SCI may also be referred to as receiving control information (RxCI). For example, the RxCI may be sent on a PRxCCH.

The following embodiments of this disclosure describe how to indicate duplex types of different mapping manners in a plurality of cases.

### Case A:

In some embodiments, the mapping manner corresponding to the duplex type is predefined in a protocol.

For example, in the at least two mapping manners that correspond to the DMRSs and that are determined based on the first information, a duplex type corresponding to each DMRS mapping manner may be determined based on the protocol predefinition. For example, a DMRS parameter used for the full-duplex time-frequency resource is predefined in the protocol, and the density of the resource occupied by the DMRSs configured for the full-duplex time-frequency resource is higher.

For example, the first information includes two DMRS parameters, and a density of a resource occupied by DMRSs in a DMRS parameter 1 is higher than a density of a resource occupied by DMRSs in a DMRS parameter 2. It may be predefined in the protocol that the DMRS parameter 1 in which the density of the resource occupied by the DMRSs is higher is used for the full-duplex time-frequency resource.

For another example, the first information includes three DMRS parameters. A density of a resource occupied by DMRSs in a DMRS parameter 1 is higher than a density of a resource occupied by DMRSs in a DMRS parameter 3, and is higher than a density of a resource occupied by DMRSs in a DMRS parameter 2. It may be predefined in the protocol that the DMRS parameter 1 in which the density of the resource occupied by the DMRSs is highest is used for the full-duplex time-frequency resource. Alternatively, it may be predefined in the protocol that the DMRS parameter 1 or the DMRS parameter 3 in which the density of the resource occupied by the DMRSs is not lowest is used for the full-duplex time-frequency resource.

### Case B:

In some embodiments, the first information further indicates the duplex type corresponding to the mapping manner.

For example, the first information may include the at least two mapping manners corresponding to the DMRSs, and indicate a duplex type corresponding to each DMRS mapping manner. For example, the first information includes a plurality of DMRS parameters, and indicates a duplex type corresponding to each DMRS parameter. For another example, a plurality of pieces of first information include a plurality of DMRS parameters, and each piece of first information includes one DMRS parameter, and indicates a duplex type corresponding to the DMRS parameter.

It may be understood that, in this embodiment of this disclosure, the first information directly indicates the duplex type corresponding to the DMRS parameter, so that the transmit end can autonomously select, based on the duplex type, a proper DMRS parameter to perform DMRS mapping.

### Case C:

In some embodiments, the method may further include: sending or receiving second information. The second information indicates the duplex type corresponding to the mapping manner.

In some examples, the transmit end may further send or receive the second information. The second information may indicate the duplex types corresponding to different mapping manners. For example, when the transmit end is the network device, the transmit end may generate the second information. The transmit end may send the second information to the terminal, so that the terminal determines, based on the second information, a duplex type corresponding to each DMRS mapping manner. For another example, when the transmit end is the terminal, the transmit end may receive the second information sent by the network device, and the transmit end determines, based on the second information, a duplex type corresponding to each DMRS mapping manner.

In some examples, the second information may be physical layer signaling. For example, the second information may be DCI. For another example, the second information may be UCI. For still another example, the second information may be SCI or the like.

For example, the first information includes a plurality of DMRS parameters, but does not indicate a duplex type corresponding to each DMRS parameter. The transmit end may indicate, by using the second information, a specific DMRS parameter that may be used for the full-duplex time-frequency resource, or may indicate a specific DMRS parameter that may be used for the non-full-duplex time-frequency resource.

In some embodiments, the second information may be carried in one or both of the following: higher layer signaling or physical layer signaling.

For example, the second information is carried in the higher layer signaling. For example, the second information is carried in RRC or a MAC CE. For another example, the second information may be carried in the physical layer signaling. For example, the second information is carried in DCI, UCI, or SCI. For still another example, second information may be carried in the higher layer signaling and the physical layer signaling.

This embodiment of this disclosure provides a plurality of possible forms in which the mapping manner corresponds to the duplex type, and proper manners may be selected to indicate a correspondence between the mapping manner and the duplex type in different scenarios. In this way, any type of signal is mapped to the full-duplex time-frequency resource and the non-full-duplex time-frequency resource in a proper mapping manner, to ensure the transmission reliability of the signal.

For indicating the DMRS mapping manner, in this embodiment of this disclosure, a plurality of DMRS mapping manners may be configured by using the first information, so that mapping may be performed in proper mapping manners for different time-frequency resources based on the first information, thereby ensuring that the data signals are parsed more accurately based on the DMRSs on different time-frequency resources.

In the communication method provided in embodiments of this disclosure, the first signal includes DMRSs, and the DMRSs include first DMRSs and second DMRSs. Different DMRSs may be mapped to a same time-frequency resource or different time-frequency resources, to ensure the transmission reliability of the DMRSs on different time-frequency resources. In a possible implementation, the method may further include: sending or receiving third information, where the third information is used to determine a mapping manner corresponding to the first DMRSs. The first DMRSs are mapped to the first time-frequency resource and the second time-frequency resource. Fourth information is sent or received, where the fourth information is used to determine a mapping manner corresponding to the second DMRSs. The second DMRSs are mapped to the second time-frequency resource.

In some embodiments, the first signal may include the DMRSs. The DMRSs may include the first DMRSs and the second DMRSs. The first DMRSs are mapped to the first time-frequency resource and the second time-frequency resource. For example, the first DMRSs may be mapped to the full-duplex time-frequency resource and the non-full-duplex time-frequency resource. The second DMRSs are mapped to the second time-frequency resource. For example, the second DMRSs may be mapped to the full-duplex time-frequency resource.

In some examples, the transmit end sends or receives the third information, where the third information may be used to determine the mapping manner corresponding to the first DMRSs. For example, the third information may be RRC signaling. For example, when the transmit end is the network device, the transmit end may generate the third information. The transmit end may send the third information to the terminal, so that the terminal determines the mapping manner of the first DMRSs based on the third information. For another example, when the transmit end is the terminal, the transmit end may receive the third information sent by the network device. The transmit end determines the mapping manner of the first DMRSs based on the third information, and the transmit end may map the first DMRSs to the first time-frequency resource and the second time-frequency resource in the mapping manner of the first DMRSs.

In some embodiments, the third information may be carried in one or more of the following: a protocol predefinition, a network configuration, higher layer signaling, or physical layer signaling.

For example, the third information is configured through protocol predefinition. For another example, the third information may be configured by the network device. For still another example, the third information may be carried in higher layer signaling. For example, the third information is carried in RRC or a MAC CE. For still another example, the third information may be carried in the physical layer signaling. For example, the third information is carried in DCI, UCI, or SCI. For still another example, the third information may be configured by the network device, and carried in the higher layer signaling. It may be understood that the third information may be carried or configured in any one or more of the foregoing manners. This is not enumerated herein in this embodiment of this disclosure.

In some examples, the transmit end sends or receives fourth information, where the fourth information may be used to determine a mapping manner corresponding to the second DMRSs. For example, the fourth information may be a MAC CE, DCI signaling, UCI signaling, or SCI signaling. For example, when the transmit end is the network device, the transmit end may generate the fourth information. The transmit end may send the fourth information to the terminal, so that the terminal determines the mapping manner of the second DMRSs based on the fourth information. For another example, when the transmit end is the terminal, the transmit end may receive the fourth information sent by the network device. The transmit end determines the mapping manner of the second DMRSs based on the fourth information, and the transmit end may map the second DMRSs to the second time-frequency resource in the mapping manner of the second DMRSs.

In some embodiments, the fourth information may be carried in one or more of the following: a protocol predefinition, a network configuration, higher layer signaling, or physical layer signaling.

For example, the fourth information is predefined in a protocol. For another example, the fourth information may be configured by the network device. For still another example, the fourth information may be carried in the higher layer signaling. For example, the fourth information is carried in RRC or a MAC CE. For still another example, the fourth information may be carried in the physical layer signaling. For example, the fourth information is carried in DCI, UCI, or SCI. For still another example, the fourth information may be configured by the network device, and carried in the higher layer signaling. It may be understood that the fourth information may be carried or configured in any one or more of the foregoing manners. This is not enumerated herein in this embodiment of this disclosure.

It may be understood that the second DMRSs may be considered as one type of additional DMRSs. However, it should be understood that the “additional DMRSs” in embodiments of this disclosure represents DMRSs newly added to the second time-frequency resource based on the first DMRSs. In other words, the “additional DMRSs” are the newly added DMRSs on the second time-frequency resource based on the first DMRSs.

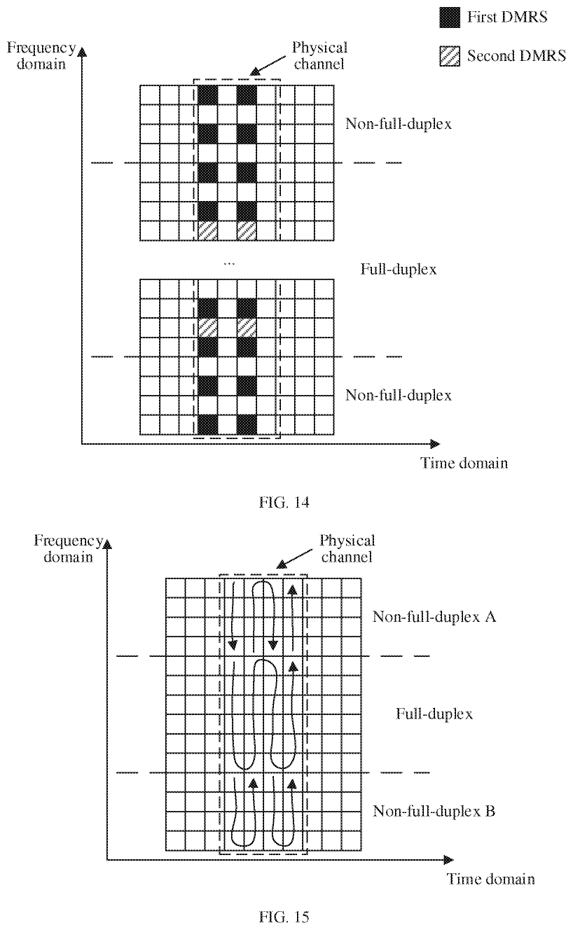

FIG. 14 is a diagram of resource mapping. It can be learned that the first DMRSs are distributed on the full-duplex time-frequency resource and the non-full-duplex time-frequency resource. The second DMRSs are distributed only on the second time-frequency resource. In this way, after the DMRSs are configured, the DMRS density on the full-duplex time-frequency resource may be higher than the DMRS density on the non-full-duplex time-frequency resource, so that the receive end better parse a signal transmitted on the full-duplex time-frequency resource more accurately.

In some embodiments, the method further includes: performing rate matching or puncturing on a time-frequency resource symmetric to the second DMRSs.

In some examples, the time-frequency resource symmetric to the second DMRSs may be understood as that a same time-frequency resource on the full-duplex time-frequency resource is used for uplink and downlink, or is used for two transmission directions of a same communication link. That the time-frequency resource is used for uplink and downlink may be referred to as mutual symmetry, or that the time-frequency resource is used for two transmission directions of the same communication link may be referred to as mutual symmetry. For example, in a scenario of a sidelink (SL) between terminals, a transmission direction in which a terminal 1 sends a signal to a terminal 2 and a transmission direction in which the terminal 2 sends a signal to the terminal 1 may be referred to as symmetry.

Refer to FIG. 14. For the second DMRSs on the full-duplex time-frequency resource, rate matching or puncturing may be performed on the symmetric time-frequency resource. For example, uplink and downlink are mutually symmetric. An uplink time-frequency resource that is symmetric to a downlink time-frequency resource and that is occupied by the second DMRSs may be referred to as a symmetric uplink avoidance resource. It is assumed that a downlink signal and an uplink signal are sent on the full-duplex time-frequency resource, and the downlink signal includes the second DMRSs. If a time-frequency resource occupied by the uplink signal includes the symmetric uplink avoidance resource, rate matching or puncturing is performed on the uplink signal on the symmetric uplink avoidance resource.

For another example, a downlink time-frequency resource that is symmetric to an uplink time-frequency resource and that is occupied by the second DMRSs may be referred to as a symmetric downlink avoidance resource. It is assumed that an uplink signal and a downlink signal are sent in the full-duplex area, and the uplink signal includes the second DMR. If a time-frequency resource occupied by the downlink signal includes the symmetric downlink avoidance resource, rate matching or puncturing is performed on the downlink signal on the symmetric downlink avoidance resource. For example, an SL scenario is used as an example. It is assumed that a transmission direction in which a terminal 1 sends a signal to a terminal 2 is a direction 1, it is assumed that a transmission direction in which the terminal 2 sends a signal to the terminal 1 is a direction 2, and the direction 1 and the direction 2 are mutually symmetric. It is assumed that the time-frequency resource occupied by the second DMRSs is referred to as a first avoidance resource when the time-frequency resource is used for the direction 1, and the time-frequency resource occupied by the second DMRSs is referred to as a second avoidance resource when the time-frequency resource is used for the direction 2. For example, it is assumed that the terminal 1 sends a signal to the terminal 2 on the full-duplex time-frequency resource, and the signal includes the second DMRSs. If a time-frequency resource occupied by the signal sent by the terminal 2 to the terminal 1 includes the second avoidance resource, rate matching or puncturing is performed on the signal sent by the terminal 2 to the terminal 1 on the second avoidance resource.

For another example, it is assumed that the terminal 2 sends a signal to the terminal 1 on the full-duplex time-frequency resource, and the signal includes the second DMRSs. If a time-frequency resource occupied by the signal sent by the terminal 1 to the terminal 2 includes the first avoidance resource, rate matching or puncturing is performed on the signal sent by the terminal 1 to the terminal 2 on the first avoidance resource.

Certainly, for a specific implementation process of rate matching and puncturing, refer to a related technology. This is not limited in this embodiment of this disclosure.

In this embodiment of this disclosure, rate matching or puncturing may be performed on the time-frequency resource symmetric to the second DMRSs, and manners of using the resources for different transmission directions may be flexibly configured.

In some embodiments, the fourth information may indicate a position of a newly added symbol. The second DMRSs are at the position of the newly added symbol. Similar to the scenario shown in FIG. 12, the second DMRSs may alternatively be indicated by using different DMRS mapping types. For example, if the mapping type A indicates the second DMRSs, the fourth information may indicate the 5^{th} symbol, the 9^{th} symbol, and the 13^{th} symbol in the slot. In other words, it indicates that the second DMRSs may be mapped to the positions. Certainly, the fourth information may alternatively indicate the 6^{th} symbol and the 10^{th} symbol in the slot, or indicate the 7^{th} symbol and the 11^{th} symbol in the slot. This is not limited in embodiments of this disclosure. For another example, if the mapping type B indicates the second DMRSs, the fourth information may indicate the 2^{nd} symbol corresponding to the physical channel. In other words, it indicates that the second DMRSs may be mapped to the position. Certainly, the fourth information may alternatively indicate the 2^{nd} symbol and the 3^{rd} symbol corresponding to the physical channel, indicate the intermediate symbol on the physical channel, or indicate a last symbol corresponding to the physical channel. This is not limited in embodiments of this disclosure.

It may be understood that frequency domain densities of the second DMRSs and the first DMRSs may be the same, and frequency domain positions of the second DMRSs and the first DMRSs may be the same or different. For details, refer to the descriptions in the corresponding embodiment in FIG. 12. Details are not described herein again in this embodiment of this disclosure.

In some embodiments, the fourth information may indicate a newly added frequency domain density and a start position. The second DMRSs and the first DMRSs are located on a same symbol. For example, the fourth information indicates that DMRSs with a density of ½, ¼, ⅙, or ⅓ are newly added to the full-duplex time-frequency resource. In addition, a relative offset, for example, an offset of 1, 2, 3, or 4, between the start position and a 0^{th} RB in the full-duplex area may be indicated. This is not limited in this embodiment of this disclosure.

In some embodiments, the fourth information may indicate the position of the newly added symbol, and may indicate the newly added frequency domain density and the start position.

In some embodiments, the third information may be a general configuration, and the fourth information may be considered as an additional new configuration. The general configuration may be predefined in the protocol, and is used to configure the first DMRSs. The physical layer signaling may indicate to use the additional new configuration for the full-duplex time-frequency resource, and the additional new configuration may be used to configure the second DMRSs. The first DMRSs and the second DMRSs are configured in the manner described in this embodiment, so that overheads of the fourth information are lower, and the second DMRSs can be configured more flexibly.

In this embodiment of this disclosure, different DMRSs may be divided based on the mapping manners, and one or more types of DMRSs may be separately mapped to the full-duplex time-frequency resource and the non-full-duplex time-frequency resource, so that it is ensured that the data signals are parsed more accurately based on the DMRSs on different time-frequency resources.

In the communication method provided in embodiments of this disclosure, the first signal may include the DMRSs. When an overall DMRS density remains unchanged, different DMRS densities may be allocated to different time-frequency resources, to ensure reliability of DMRS transmission on different time-frequency resources. In some possible implementations, the method may further include: sending or receiving fifth information. The fifth information is used to determine the mapping manner corresponding to the DMRSs. The density of the resource occupied by the DMRSs is a first value, and the mapping manner corresponding to the DMRSs is represented in the following manner: The density of a resource occupied by the DMRSs on the second time-frequency resource is higher than the density of a resource occupied by the DMRSs on the first time-frequency resource.

In some embodiments, the first signal may include the DMRSs. The transmit end may further send or receive the fifth information. The fifth information may be used to determine the mapping manner corresponding to the DMRSs.

For example, the density of the resource occupied by the DMRSs is the first value. It may be understood that the overall density of the resource occupied by the DMRSs remains unchanged. In other words, for the physical channel, the density of the resource occupied by the DMRSs remains the first value. In other words, in a specific time-frequency resource range, a quantity of REs used for the DMRS/a total quantity of REs on the time-frequency resource remains unchanged. In some examples, the density of the resource occupied by the DMRSs on the second time-frequency resource is higher than the density of the resource occupied by the DMRSs on the first time-frequency resource. In other words, when it is ensured that a total quantity of DMRSs on the physical channel remains unchanged, more DMRSs may be mapped to the second time-frequency resource as much as possible.

In some examples, the density of the resource occupied by the DMRSs may include a time domain density and/or a frequency domain density.

In some examples, the transmit end may be the network device, and the transmit end may generate the fifth information. The transmit end may send the fifth information to the terminal, so that the terminal determines, based on the fifth information, the mapping manner corresponding to the DMRSs. In some other examples, the transmit end may be the terminal, and the transmit end may receive the fifth information sent by the network device. The transmit end may determine, based on the fifth information, the mapping manner corresponding to the DMRSs.

In some embodiments, the fifth information may be carried in one or more of the following: a protocol predefinition, a network configuration, higher layer signaling, or physical layer signaling.

For example, the fifth information is predefined in the protocol. For another example, the fifth information may be configured by the network device. For still another example, the fifth information may be carried in the higher layer signaling. For example, the fifth information is carried in RRC or a MAC CE. For still another example, the fifth information may be carried in the physical layer signaling. For example, the fifth information is carried in DCI, UCI, or SCI. For still another example, the fifth information may be configured by the network device, and carried in the higher layer signaling. It may be understood that the fifth information may be carried or configured in any one or more of the foregoing manners. This is not enumerated herein in this embodiment of this disclosure.

In this embodiment of this disclosure, when an overall DMRS density remains unchanged, different DMRS densities may be allocated to different time-frequency resources, to ensure that the data signals are parsed more accurately based on the DMRSs on different time-frequency resources.

Scenario 2: The first signal is the data signals.

In the communication method provided in embodiments of this disclosure, the first signal includes the data signals. The data signals may be sequentially mapped to different time-frequency resources based on mapping priorities, to ensure the transmission reliability of the data signals. For example, different time-frequency resources are the first time-frequency resource and the second time-frequency resource. The data signals are sequentially mapped to the first time-frequency resource and the second time-frequency resource.

In some embodiments, the first signal may include the data signals. The data signals may be sequentially mapped to different time-frequency resources. For example, the data signals are sequentially mapped to the first time-frequency resource and the second time-frequency resource. In other words, the data signals are first mapped to the first time-frequency resource and then mapped to the second time-frequency resource.

It may be understood that it is assumed that the first time-frequency resource is the non-full-duplex time-frequency resource, and the second time-frequency resource is the full-duplex time-frequency resource. Considering that interference on the full-duplex time-frequency resource is more severe than interference on the non-full-duplex time-frequency resource, it is preferentially considered that the data signals are mapped to the non-full-duplex time-frequency resource, to improve reliability of the data signals in a communication process. When no data signal can be mapped to the full-duplex time-frequency resource, remaining data signals that are not mapped are mapped to the full-duplex time-frequency resource.

In some examples, in a process of mapping the data signals to the time-frequency resource, the data signals may be mapped to a corresponding time-frequency resource in a sequence of frequency domain first and then time domain. Refer to FIG. 15. The data signals may be first mapped to the non-full-duplex time-frequency resource, and the data signals may be sequentially mapped to the non-full-duplex time-frequency resource in the sequence of frequency domain first and then time domain, for example, in arrow directions on the non-full-duplex time-frequency resource in FIG. 15. It can be learned that, on a 1^{st} symbol corresponding to a physical channel, mapping is first performed on a time-frequency resource of non-full-duplex A, and then performed on a time-frequency resource of non-full-duplex B. Then, after the mapping performed on the 1^{st} symbol is completed, mapping is performed on a 2^{nd} symbol. For example, on the 2^{nd} symbol corresponding to the physical channel, mapping may be first performed on the time-frequency resource of the non-full-duplex B, and then performed on the time-frequency resource of the non-full-duplex A. The mapping process is similar to an “S” type. On a same symbol, mapping may be performed in descending order of frequency domain, or may be performed in ascending order of frequency domain. It should be clear that arrows in FIG. 15 are merely examples for description, and this is not limited in this embodiment of this disclosure. Similarly, on the full-duplex time-frequency resource, in a sequence of the arrows in FIG. 15, mapping is first performed on the 1^{st} symbol in frequency domain, and then performed on the 2^{nd} symbol. It may be understood that the time-frequency resource of the non-full-duplex A and the time-frequency resource of the non-full-duplex B belong to a same non-full-duplex time-frequency resource. If the time-frequency resource of the non-full-duplex A and the time-frequency resource of the non-full-duplex B are observed as a whole, a mapping manner is similar to a mapping manner on the full-duplex time-frequency resource.

It may be understood that the DMRSs are not shown in FIG. 15. However, in actual mapping, the data signals are not mapped to the time-frequency resource occupied by the DMRSs in a mapping process, and is mapped to an idle time-frequency resource.

In this embodiment of this disclosure, the data signals may be preferentially mapped to the non-full-duplex time-frequency resource, to ensure the transmission reliability of the data signals.

In some embodiments, the data signals include first-type data signals and second-type data signals. A data priority of the first-type data signals is different from a data priority of the second-type data signals. An order in which different data signals are sequentially mapped to the first time-frequency resource and the second time-frequency resource is determined based on the data priorities.

In some examples, the data signals may include a plurality of types of data signals, and different types of data signals may correspond to different data priorities. For example, the data signals include first-type data signals and second-type data signals, and the data priority of the first-type data signals is different from the data priority of the second-type data signals. The sequence of sequentially mapping the first-type data signals and the second-type data signals to the first time-frequency resource and the second time-frequency resource may be determined based on the data priority of the first-type data signals and the data priority of the second-type data signals.

For example, the data priority of the first-type data signals is higher than the data priority of the second-type data signals. In this case, the first-type data signals may be first mapped, and then the second-type data signals may be mapped. To be specific, the first-type data signals are first mapped to the non-full-duplex time-frequency resource, and if the first-type data signals are not completely mapped, the first-type data signals continue to be mapped to the full-duplex time-frequency resource. After the first-type data signals are completely mapped, the second-type data signals continue to be mapped. Certainly, if the first-type data signals are completely mapped to the non-full-duplex time-frequency resource, assuming that there is still a remaining resource that is on the non-full-duplex time-frequency resource and on which mapping is not performed, the second-type data signals may be first mapped to the remaining resource that is on the non-full-duplex time-frequency resource and on which the mapping is not performed, and then mapped to the full-duplex time-frequency resource.

In some examples, the first-type data signals may be URLLC data signals. The second-type data signals may be eMBB data signals.

It may be understood that the priority in embodiments of this disclosure is, for example, a data priority or a mapping priority. If a data priority of specific data signals is higher, it indicates that this type of data signals needs to be mapped more preferentially. If a mapping priority of a specific time-frequency resource is higher, it indicates that the data signals are mapped more preferentially to the time-frequency resource. If a mapping priority of a specific time-frequency resource is lower, it indicates that the DMRSs are mapped more preferentially to the time-frequency resource. In embodiments of this disclosure, a higher mapping priority of a time-frequency resource indicates lower interference on the time-frequency resource. On the contrary, a lower mapping priority of a time-frequency resource indicates more severe interference on the time-frequency resource. Certainly, whether a larger priority value indicates a higher priority or a smaller priority value indicates a higher priority may be determined in a proper manner based on an actual situation. This is not limited in this embodiment of this disclosure.

It should be noted that, when the DMRSs are mapped, it may alternatively be considered that a mapping priority of a time-frequency resource to which the DMRSs are preferentially mapped is higher. In this case, a higher mapping priority of a time-frequency resource indicates more severe interference on the time-frequency resource. On the contrary, a lower mapping priority of a time-frequency resource indicates lower interference on the time-frequency resource.

In some examples, the URLLC data signals may alternatively include first-type URLLC data signals and second-type URLLC data signals. A data priority of the first-type URLLC data signals is higher than a data priority of the second-type URLLC data signals. In this case, the first-type URLLC data signals may be first mapped, and then the second-type URLLC data signals are mapped. Assuming that there are still the eMBB data signals, data priorities are as follows: data priority of the first-type URLLC data signals>data priority of the second-type URLLC data signals>data priority of the eMBB data signals. In this case, the eMBB data signals are mapped after the second-type URLLC data signals are completely mapped.

In some examples, the URLLC data signals may alternatively include initially transmitted URLLC data signals and retransmitted URLLC data signals. A data priority of the initially transmitted URLLC data signals is higher than a data priority of the retransmitted URLLC data signals. In this case, the initially transmitted URLLC data signals may be first mapped, and then the retransmitted URLLC data signals are mapped. Assuming that there are still the eMBB data signals, data priorities are as follows: data priority of the initially transmitted URLLC data signals>data priority of the retransmitted URLLC data signals>data priority of the eMBB data signals. In this case, the eMBB data signals are mapped after the second-type URLLC data signals are completely mapped.

For another example, if the initially transmitted URLLC data signals include first-type initially transmitted URLLC data signals and second-type initially transmitted URLLC data signals, where a data priority of the first-type initially transmitted URLLC data signals is higher than a data priority of the second-type initially transmitted URLLC data signals. Similarly, if the retransmitted URLLC data signals include first-type retransmitted URLLC data signals and second-type retransmitted URLLC data signals, where a data priority of the first-type retransmitted URLLC data signals is higher than a data priority of the second-type retransmitted URLLC data signals. Assuming that there are still the eMBB data signals, data priorities are as follows: data priority of the first-type initially transmitted URLLC data signals>data priority of the second-type initially transmitted URLLC data signals>data priority of the first-type retransmitted URLLC data signals>data priority of the second-type retransmitted URLLC data signals>data priority of the eMBB data signals. In this case, mapping may be sequentially performed from data signals with a highest priority based on the priority sequence, until all data signals are completely mapped.

Certainly, there may be more or fewer data signals. A data priority relationship between data signals of different types may be determined based on the actual situation. This is not limited in this embodiment of this disclosure.

In this embodiment of this disclosure, different types of data signals may have different data priorities. A sequence of mapping different data signals may be determined based on different data priorities, to ensure the transmission reliability of different types of data signals on the non-full-duplex time-frequency resource and the full-duplex time-frequency resource.

Next, data signals sent on the first time-frequency resource and the second time-frequency resource are configured in different dimensions.

### Dimension 1:

In some embodiments, when the first signal includes the data signals, sending the data signals on the first time-frequency resource and the second time-frequency resource may meet the following: A quantity of retransmissions corresponding to the data signals transmitted on the second time-frequency resource is greater than a quantity of retransmissions corresponding to the data signals transmitted on the first time-frequency resource.

In some examples, to ensure reliability of the data signals in the communication process, the data signals may be sent in a data retransmission manner. Considering that the interference on the full-duplex time-frequency resource is more severe than the interference on the non-full-duplex time-frequency resource, more retransmissions of the data signals may be performed on the full-duplex time-frequency resource. For example, the quantity of retransmissions corresponding to the data signals transmitted on the second time-frequency resource may be greater than the quantity of retransmissions corresponding to the data signals transmitted on the first time-frequency resource. Therefore, transmission reliability of the data signals on the second time-frequency resource is improved.

For example, the quantity of retransmissions corresponding to the data signals transmitted on the first time-frequency resource may be 1, and the quantity of retransmissions corresponding to the data signals transmitted on the second time-frequency resource may be 2. Certainly, a specific quantity of retransmissions is not limited in this embodiment of this disclosure.

The quantity of retransmissions in embodiments of this disclosure may be considered to correspond to only a quantity of repeated transmissions other than a 1^{st} transmission, or may be considered to include a total quantity of a 1^{st} transmission and a subsequent repeated transmission. This is not limited in this embodiment of this disclosure.

### Dimension 2:

In some embodiments, when the first signal includes the data signals, sending the data signals on the first time-frequency resource and the second time-frequency resource may meet the following: A modulation and coding scheme (MCS) for transmitting the data signals on the second time-frequency resource is lower than an MCS for transmitting the data signals on the first time-frequency resource.

In some examples, to ensure reliability of the data signals in the communication process, different MCSs may be used for data signals sent on different time-frequency resources. The MCS for transmitting the data signals on the second time-frequency resource may be different from the MCS for transmitting the data signals on the first time-frequency resource. In some examples, the MCS includes a code rate and a modulation order. For example, different MCSs may mean different code rates, may mean different modulation orders, or may mean both different code rates and different modulation orders.

For example, a higher code rate indicates lower sending reliability of data signals. Therefore, for different data signals, data signals with a higher data priority are sent at a lower code rate. For example, if the data priority of the first-type data signals is higher than the data priority of the second-type data signals, a code rate of an MCS used for the first-type data signals may be lower than a code rate of an MCS used for the second-type data signals.

For example, a higher modulation order indicates lower sending reliability of data signals. Therefore, for different data signals, data signals with a higher data priority are sent by using a lower modulation order. For example, if the data priority of the first-type data signals is higher than the data priority of the second-type data signals, a modulation order of an MCS used for the first-type data signals may be lower than a modulation order of an MCS used for the second-type data signals. For example, the first-type data signals are modulated through 16 quadrature amplitude modulation (QAM), and the second-type data signals are modulated through quadrature phase shift keying (QPSK).

For example, if both the code rates and the modulation orders are different, a proper code rate and a proper modulation order may be selected based on the actual situation, to meet reliability requirements of different data signals. For details, refer to descriptions in the foregoing embodiments. Details are not described herein again in this embodiment of this disclosure.

### Dimension 3:

In some embodiments, when the first signal includes the data signals, sending the data signals on the first time-frequency resource and the second time-frequency resource may meet the following: A quantity of layers for transmitting the data signals on the second time-frequency resource is less than a quantity of layers for transmitting the data signals on the first time-frequency resource.

In some examples, to ensure reliability of the data signals in the communication process, data signals sent on different time-frequency resources may be sent on different quantities of layers.

For example, a smaller quantity of layers indicates higher sending reliability of data signals. Therefore, for different data signals, data signals with a higher data priority are sent on a smaller quantity of layers. For example, if the data priority of the first-type data signals is higher than the data priority of the second-type data signals, a quantity of layers used for the first-type data signals may be less than a quantity of layers used for the second-type data signals.

For example, the transmit end may send or receive signaling indicating the quantity of layers. For example, the signaling may separately indicate the quantities of layers used for the data signals on different time-frequency resources. For example, it indicates that a quantity of layers used for the data signals on the first time-frequency resource is 2, and indicates that a quantity of layers used for the data signals on the second time-frequency resource is 1. For another example, a relationship between the quantities of layers used for the data signals on different time-frequency resources may be predefined in the protocol, and the signaling indicates only the quantity of layers. For example, a relationship that the quantity of layers used for the data signals on the first time-frequency resource is 1 and the quantity of layers used for the data signals on the second time-frequency resource is 2 may be predefined in the protocol. The signaling only indicates that the quantity of layers is 2.

In this embodiment of this disclosure, the data signals may have different configurations on the non-full-duplex time-frequency resource and the full-duplex time-frequency resource, to ensure the transmission reliability of the data signals on the corresponding time-frequency resources.

In the communication method provided in embodiments of this disclosure, the different time-frequency resources are determined in any one of the following manners: predefined in a protocol; or determined through division based on a channel measurement result.

In some embodiments, the first time-frequency resource and the second time-frequency resource may be predefined in the protocol.

In some embodiments, the transmit end may determine the first time-frequency resource and the second time-frequency resource based on a channel measurement result. Alternatively, the receive end may determine the first time-frequency resource and the second time-frequency resource based on the channel measurement result. The receive end may notify the transmit end of a division status of the time-frequency resources.

For example, the channel measurement result may be a channel state information (CSI) report obtained by the terminal through measurement based on a channel state information-reference signal (CSI-RS), or a cross-link interference (CLI) report obtained by the terminal through measurement. For another example, the channel measurement result may be a channel measurement result obtained by the network device through measurement based on a sounding reference signal (SRS).

This embodiment of this disclosure provides a plurality of manners of determining different time-frequency resources, and is applicable to time-frequency resource division in different scenarios, to improve universality.

FIG. 16 is a flowchart of another communication method according to an embodiment of this disclosure.

As shown in FIG. 16, this communication process is applicable to, but is not limited to, the communication scenarios shown in FIG. 1 and FIG. 4 to FIG. 8. The method may be applied to a transmit end. The transmit end may be various possible devices in the foregoing scenarios, such as the terminal, the network device, the satellite, the IAB node, and the IAB donor node. This is not limited in embodiments of this disclosure. The method may include the following steps.

S201: The transmit end determines at least two time-frequency resources.

In some embodiments, the transmit end may determine the at least two time-frequency resources. N time-frequency resources in the at least two time-frequency resources correspond to different mapping priorities. N is a positive integer greater than or equal to 2.

For example, it is assumed that the transmit end determines four time-frequency resources. For example, time-frequency resources in the four time-frequency resources all correspond to different mapping priorities. For another example, mapping priorities corresponding to three time-frequency resources in the four time-frequency resources are different, and a mapping priority corresponding to a remaining time-frequency resource is the same as a mapping priority corresponding to a specific time-frequency resource in the three time-frequency resources.

In some embodiments, the at least two time-frequency resources may be determined based on a channel measurement result and at least one measurement result threshold.

In some examples, the transmit end may determine the at least two time-frequency resources based on the channel measurement result obtained through channel measurement and the at least one measurement result threshold. For example, a time-frequency resource corresponding to a physical channel is divided into at least two time-frequency resources.

For example, a network device may directly perform measurement based on an SRS sent by a terminal, to obtain the channel measurement result. Alternatively, a network device receives a CSI report or a CLI report sent by a terminal, and obtains the channel measurement result based on the CSI report or the CLI report. The CSI report may be obtained by the terminal through measurement based on a CSI-RS sent by the network device. The network device divides the time-frequency resource corresponding to the physical channel into the at least two time-frequency resources based on the obtained channel measurement result and the at least one preset measurement result threshold.

In some examples, the channel measurement result may be at least one of a received signal strength indication (RSSI), reference signal received power (RSRP), reference signal received quality (RSRQ), or a signal to interference plus noise ratio (SINR). Certainly, the channel measurement result may further include any other possible parameter. This is not limited in this embodiment of this disclosure.

Refer to FIG. 17. A measurement result threshold 1 and a measurement result threshold 2 may be preset measurement result thresholds. The network device may divide, based on the channel measurement result, the measurement result threshold 1, and the measurement result threshold 2, the time-frequency resource corresponding to the physical channel. As shown in FIG. 17, three time-frequency resources may alternatively be obtained through division. A channel measurement result corresponding to one of the three time-frequency resources is less than the measurement result threshold 1; a channel measurement result corresponding to another time-frequency resource is less than the measurement result threshold 2 and is greater than or equal to the measurement result threshold 1; and a channel measurement result corresponding to a last time-frequency resource is greater than or equal to the measurement result threshold 2. Certainly, a time-frequency resource whose channel measurement result is equal to the measurement result threshold 1 may alternatively be grouped together with a time-frequency resource whose channel measurement result is less than the measurement result threshold 1. Similarly, a time-frequency resource whose channel measurement result is equal to the measurement result threshold 2 may alternatively be grouped together with the time-frequency resource whose channel measurement result is less than the measurement result threshold 2. This is not limited in embodiments of this disclosure.

It may be understood that mapping priorities corresponding to different time-frequency resources may be the same or different. For example, different time-frequency resources obtained through division in FIG. 17 all correspond to different channel measurement results. In this case, different time-frequency resources correspond to different mapping priorities. For another example, it is assumed that the time-frequency resource whose channel measurement result is less than the measurement result threshold 1 is divided into a plurality of non-adjacent time-frequency resources on the physical channel. In this case, mapping priorities corresponding to the plurality of time-frequency resources may be the same.

It should be noted that, for the channel measurement result mentioned above, in some scenarios, the mapping priorities corresponding to different time-frequency resources may need to be determined based on different cases in which the device performs measurement or another device performs measurement. The mapping priorities corresponding to different time-frequency resources are not determined only based on a value of the channel measurement result.

In some examples, refer to FIG. 17. A first mapping priority, a second mapping priority, and a third mapping priority may be allocated to the three time-frequency resources. For example, a larger value may indicate a higher mapping priority. For another example, a smaller value may indicate a higher mapping priority. A correspondence between a value and a priority is not limited in embodiments of this disclosure.

In some embodiments, the at least two time-frequency resources may be obtained in a protocol-predefined manner.

In some examples, for example, the at least two time-frequency resources may be predefined in a protocol. The network device may determine, based on the channel measurement result, mapping priorities corresponding to the at least two time-frequency resources.

For example, three time-frequency resources: a time-frequency resource 1, a time-frequency resource 2, and a time-frequency resource 3 are predefined in the protocol. The network device may determine, based on the channel measurement result, that a mapping priority corresponding to the time-frequency resource 1 is higher than a mapping priority corresponding to the time-frequency resource 3, and is higher than a mapping priority corresponding to the time-frequency resource 2.

In some examples, sequences of mapping priorities obtained based on different measurement results may be different. Therefore, refer to Table 1 and Table 2. Different sequence numbers represent different priority sequences. Table 1 is described by using two time-frequency resources as an example, and Table 2 is described by using three time-frequency resources as an example. However, a specific quantity of time-frequency resources and a correspondence between a priority sequence of time-frequency resources and sequence numbers are not limited in embodiments of this disclosure.

TABLE 1

| Sequence | |
|---|---|
| number | Priority sequence |
| 0 | Time-frequency resource 1 and time-frequency resource 2 |
| 1 | Time-frequency resource 2 and time-frequency resource 1 |

TABLE 2

| Sequence | |
|---|---|
| number | Priority sequence |
| 0 | Time-frequency resource 1, time-frequency resource 2, and |
| | time-frequency resource 3 |
| 1 | Time-frequency resource 1, time-frequency resource 3, and |
| | time-frequency resource 2 |
| 2 | Time-frequency resource 2, time-frequency resource 1, and |
| | time-frequency resource 3 |
| 3 | Time-frequency resource 2, time-frequency resource 3, and |
| | time-frequency resource 1 |
| 4 | Time-frequency resource 3, time-frequency resource 1, and |
| | time-frequency resource 2 |
| 5 | Time-frequency resource 3, time-frequency resource 2, and |
| | time-frequency resource 1 |

In embodiments of this disclosure, a higher mapping priority of a time-frequency resource may indicate lower interference on the time-frequency resource.

This embodiment of this disclosure provides a plurality of manners of determining different time-frequency resources, and is applicable to time-frequency resource division in different scenarios, to improve universality.

In some embodiments, if the transmit end is the network device, the transmit end may further send indication information indicating the at least two time-frequency resources.

In some examples, refer to Table 1 and Table 2. The indication information sent by the transmit end may further carry the sequence numbers in Table 1 and Table 2, to indicate a relationship between the mapping priorities of different time-frequency resources.

In some embodiments, if the transmit end is the terminal, the transmit end may further receive indication information indicating the at least two time-frequency resources.

In some examples, refer to Table 1 and Table 2. The indication information received by the transmit end may further carry the sequence numbers in Table 1 and Table 2, so that a receive end determines a relationship between the mapping priorities of different time-frequency resources based on the sequence numbers.

In some examples, the indication information in the foregoing examples may indicate frequency domain positions of the at least two time-frequency resources, for example, indicate start positions and continuous widths of the frequency domain positions, or for another example, indicate end positions and continuous widths of the frequency domain positions.

In this embodiment of this disclosure, different time-frequency resources may be indicated by using the indication information, so that a plurality of time-frequency resources can be allocated more flexibly.

In some embodiments, a duplex type corresponding to M time-frequency resources in the at least two time-frequency resources includes full-duplex and non-full-duplex. A duplex type corresponding to other time-frequency resources in the at least two time-frequency resources other than the M time-frequency resources includes non-full-duplex. M is a positive integer.

In other words, in a part of the at least two time-frequency resources, for example, the M time-frequency resources, each of the M time-frequency resources may include a full-duplex time-frequency resource and a non-full-duplex time-frequency resource. The other time-frequency resources in the at least two time-frequency resources other than the M time-frequency resources may be non-full-duplex time-frequency resources.

In some embodiments, a duplex type corresponding to M time-frequency resources in the at least two time-frequency resources includes full-duplex, and a duplex type corresponding to other time-frequency resources in the at least two time-frequency resources other than the M time-frequency resources includes full-duplex and non-full-duplex. M is a positive integer.

In other words, in a part of the at least two time-frequency resources, for example, the M time-frequency resources, each of the M time-frequency resources may be a full-duplex time-frequency resource. The other time-frequency resources in the at least two time-frequency resources other than the M time-frequency resources may include a full-duplex time-frequency resource and a non-full-duplex time-frequency resource.

In some embodiments, a duplex type corresponding to M time-frequency resources in the at least two time-frequency resources includes full-duplex, and a duplex type corresponding to other time-frequency resources in the at least two time-frequency resources other than the M time-frequency resources includes non-full-duplex. M is a positive integer.

In other words, in a part of the at least two time-frequency resources, for example, the M time-frequency resources, each of the M time-frequency resources may be a full-duplex time-frequency resource. The other time-frequency resources in the at least two time-frequency resources other than the M time-frequency resources may be non-full-duplex time-frequency resources.

This embodiment of this disclosure provides a plurality of possible forms in which different time-frequency resources correspond to the duplex types, so that a signal can be sent on any possible duplex type of time-frequency resource based on a mapping priority of the time-frequency resource, to ensure the transmission reliability of the signal.

S202: The transmit end sends a first signal based on the at least two time-frequency resources.

In some embodiments, the transmit end may send the first signal based on the at least two time-frequency resources determined in S201.

In some embodiments, the first signal may include DMRSs.

In some embodiments, the first signal may include data signals.

In some embodiments, the first signal may include DMRSs and data signals.

This embodiment of this disclosure provides a plurality of possible forms of the first signal, to ensure the transmission reliability of corresponding types of signals in different scenarios.

In some embodiments, densities of the DMRSs are determined based on the mapping priorities corresponding to the at least two time-frequency resources.

For example, DMRS densities of DMRSs mapped to different time-frequency resources may be determined based on mapping priorities corresponding to the corresponding time-frequency resources. In other words, a density of DMRSs on each of the at least two time-frequency resources needs to be determined based on a mapping priority corresponding to the time-frequency resource.

For example, a low DMRS density may be assigned to a time-frequency resource with low interference, for example, a time-frequency resource with a high mapping priority. Considering that interference on this type of time-frequency resource is low, no more DMRSs are needed to assist in demodulation optimization. However, a high DMRS density may be assigned to a time-frequency resource with high interference, for example, a time-frequency resource with a low mapping priority. Considering that interference on this type of time-frequency resource is severe, more DMRSs are needed to assist in demodulation optimization.

Certainly, for a specific manner of determining the DMRS density and a value relationship between the DMRS densities on the time-frequency resources, refer to the embodiments described in FIG. 9 to FIG. 15. Details are not described herein again in this embodiment of this disclosure.

In this embodiment of this disclosure, densities of DMRSs on time-frequency resources may be determined based on mapping priorities of different time-frequency resources, so that it is ensured that the data signals can be parsed more accurately based on the DMRSs on the time-frequency resources.

In some embodiments, a sequence of mapping the data signals to the at least two time-frequency resources is determined based on the mapping priorities corresponding to the at least two time-frequency resources. In other words, the transmit end may determine, based on the mapping priorities corresponding to the at least two time-frequency resources, the sequence of mapping the data signals to the at least two time-frequency resources.

For example, for a time-frequency resource with low interference, for example, a time-frequency resource with a high mapping priority, the data signals are preferentially mapped to this type of time-frequency resource, to ensure sending reliability of the data signals. Certainly, for a specific sequence of mapping the data signals to a plurality of time-frequency resources, refer to the embodiments described in FIG. 9 to FIG. 15. Details are not described herein again in this embodiment of this disclosure.

In this embodiment of this disclosure, the sequence of mapping the data signals to different time-frequency resources may be determined based on the mapping priorities, to ensure the transmission reliability of the data signals.

In some embodiments, the data signals have data priorities, and the sequence of mapping the data signals to the at least two time-frequency resources is determined based on the data priorities and the mapping priorities corresponding to the at least two time-frequency resources. In other words, the transmit end may determine, based on the data priorities and the mapping priorities corresponding to the at least two time-frequency resources, the sequence of mapping different types of data signals to the at least two time-frequency resources.

For example, assuming that a higher data priority indicates more important data, data signals with a high data priority may be preferentially mapped. In addition, in a process of mapping the data signals with the high data priority, the data signals with the high data priority are preferentially mapped to a time-frequency resource with low interference, for example, a time-frequency resource with a high mapping priority, to ensure sending reliability of the data signals. Certainly, for the specific sequence of mapping different types of data signals to a plurality of time-frequency resources, refer to the embodiments described in FIG. 9 to FIG. 15. Details are not described herein again in this embodiment of this disclosure.

In embodiments of this disclosure, different types of data signals may have different data priorities. The sequence of mapping different data signals may be determined based on different data priorities, to ensure the transmission reliability of different types of data signals on different time-frequency resources.

It can be learned that, based on the solution described in FIG. 16, in this embodiment of this disclosure, a plurality of different time-frequency resources may correspond to different mapping priorities. Signals may be sent on different time-frequency resources based on different mapping priorities, to ensure their transmission reliability.

It should be noted that the foregoing plurality of embodiments may be combined, and a combined solution is implemented. Optionally, some operations in procedures of method embodiments are randomly combined, and/or a sequence of some operations is randomly changed. In addition, an execution sequence between steps of each procedure is merely an example, and does not constitute a limitation on an execution sequence between the steps. The steps may alternatively be performed in another execution sequence. This is not intended to indicate that the execution sequence is the only sequence in which these operations can be performed. A person of ordinary skill in the art may figure out a plurality of manners to reorder the operations in this specification. In addition, it should be noted that process details related to a specific embodiment in this specification are also applicable to another embodiment in a similar manner, or different embodiments may be used in combination.

It may be understood that to implement functions in the foregoing embodiments, a base station and a terminal include corresponding hardware structures and/or software modules for performing various functions. A person skilled in the art should be easily aware that, in embodiments of this disclosure, the units and method steps in the examples described with reference to embodiments disclosed in embodiments of this disclosure can be implemented by hardware or a combination of hardware and computer software. Whether a function is performed by hardware or hardware driven by computer software depends on particular application scenarios and design constraint conditions of the technical solutions.

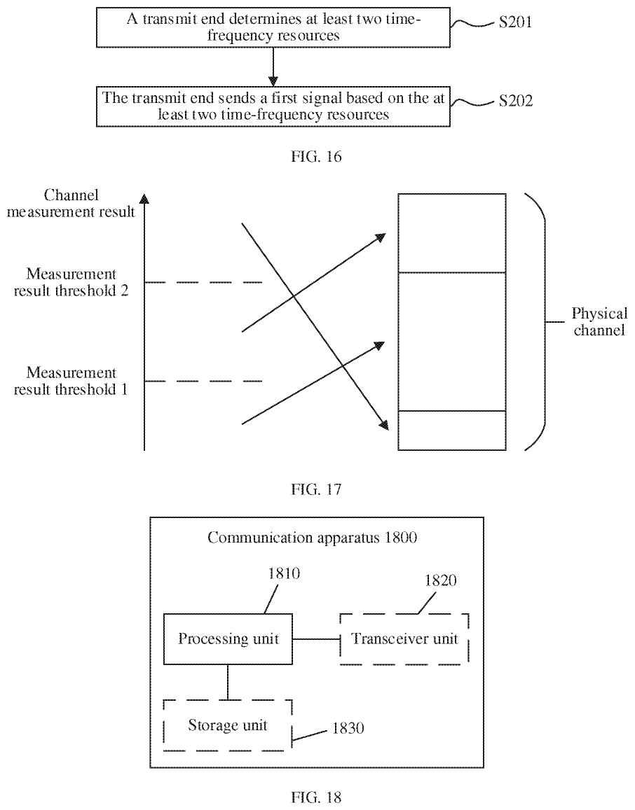

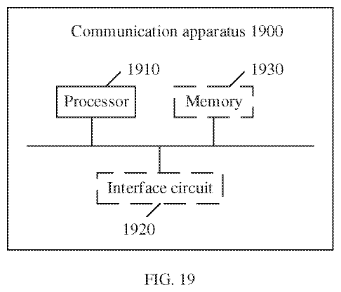

FIG. 18 and FIG. 19 are diagrams of structures of possible communication apparatuses according to embodiments of this disclosure. These communication apparatuses may be configured to implement a function of any possible transmit end in the foregoing method embodiments, and therefore can also implement beneficial effects of the foregoing method embodiments. In this embodiment of this disclosure, the communication apparatus may be the transmit end, or may be a module used in the transmit end, for example, a chip.

As shown in FIG. 18, a communication apparatus 1800 includes a processing unit 1810.

In a possible implementation, the communication apparatus 1800 may further include a transceiver unit 1820.

In a possible implementation, the communication apparatus 1800 may further include a storage unit 1830.

In a possible implementation, the communication apparatus 1800 may further include a transceiver unit 1820 and a storage unit 1830.

The communication apparatus 1800 is configured to implement a function of any node in the method embodiments shown in FIG. 9 and FIG. 16.

When the communication apparatus 1800 is configured to implement a function of any node in the method embodiment shown in FIG. 9, the processing unit 1810 is configured to determine a first time-frequency resource and a second time-frequency resource. The transceiver unit 1820 is configured to send a first signal based on the first time-frequency resource and the second time-frequency resource. The processing unit 1810 is further configured to perform all operations performed by the communication apparatus 1800 in the embodiment shown in FIG. 9 except the receiving and sending operations, and/or configured to support another process of the technology described in this specification. The storage unit 1830 is configured to store any data, computer instructions, and/or a computer program that may be used in embodiments of this disclosure.

When the communication apparatus 1800 is configured to implement a function of any node in the method embodiment shown in FIG. 16, the processing unit 1810 is configured to determine at least two time-frequency resources. The transceiver unit 1820 is configured to send a first signal based on at least two time-frequency resources. The processing unit 1810 is further configured to perform all operations performed by the communication apparatus 1800 in the embodiment shown in FIG. 16 except the receiving and sending operations, and/or configured to support another process of the technology described in this specification. The storage unit 1830 is configured to store any data, computer instructions, and/or a computer program that may be used in embodiments of this disclosure.

For more detailed descriptions of the processing unit 1810 and the transceiver unit 1820, refer to related descriptions in the method embodiments shown in FIG. 9 and FIG. 16. The processing unit 1810 and the transceiver unit 1820 may further perform other steps. For specific implementation, refer to method embodiments. Details are not described herein again.

Optionally, the transceiver unit 1820 may be a transceiver, and the transceiver may include an antenna, a radio frequency circuit, and the like.

The processing unit 1810 may be a processor (or a processing circuit), for example, a baseband processor. The baseband processor may include one or more CPUs.

As shown in FIG. 19, a communication apparatus 1900 includes at least one processor 1910. In a possible implementation, the communication apparatus 1900 may further include an interface circuit 1920.

In a possible implementation, the communication apparatus 1900 may further include a memory 1930.

In a possible implementation, the communication apparatus 1900 may further include a memory 1930 and an interface circuit 1920.

In some embodiments, the processor 1910 and the memory 1930 are coupled to each other; and/or the processor 1910 and the interface circuit 1920 are coupled to each other. It may be understood that the interface circuit 1920 may be a transceiver or an input/output interface. The memory 1930 may be configured to store computer instructions executed by the processor 1910, store input data required by the processor 1910 to run computer instructions, or store data generated after the processor 1910 runs computer instructions.

When the communication apparatus 1900 is configured to implement the methods shown in FIG. 9 and FIG. 16, the processor 1910 may be configured to implement a function of the processing unit 1810, and/or the interface circuit 1920 may be configured to implement a function of the transceiver unit 1820, and/or the memory 1930 may be configured to implement a function of the storage unit 1830.

The communication apparatus shown in FIG. 18 or FIG. 19 is merely an example. In actual application, the communication apparatus may have more or fewer components than those shown in FIG. 18 or FIG. 19, may combine two or more components, or may have different component configurations.

In this embodiment of this disclosure, that an entity A sends information to an entity B may be that A directly sends the information to B, or may be that A indirectly sends the information to B via another entity. Similarly, that the entity B receives the information from the entity A may be that the entity B directly receives the information sent by the entity A, or may be that the entity B indirectly receives the information sent by the entity A via another entity. The entity A and the entity B herein each may be a RAN node or a terminal, or may be a module in a RAN node or a terminal. Information sending and receiving may be information exchange between the RAN node and the terminal, for example, information exchange between a network device and the terminal. Information sending and receiving may alternatively be information exchange between two RAN nodes, for example, information exchange between a CU and a DU. Information sending and receiving may alternatively be information exchange between different modules in an apparatus, for example, information exchange between a chip in the terminal and another module in the terminal, or information exchange between a chip in a network device and another module in the network device.

In this embodiment of this disclosure, the network device sends a downlink signal or downlink information to the terminal device. The downlink information is carried on a downlink channel. The terminal device sends an uplink signal or uplink information to the network device. The uplink information is carried on an uplink channel. To communicate with the network device, the terminal device needs to establish a wireless connection to a cell controlled by the network device. The cell that establishes the wireless connection to the terminal device is referred to as a serving cell of the terminal device.

It may be understood that in embodiments of this disclosure, a PDSCH and a PUSCH are merely used as examples of a downlink data channel and an uplink data channel. In different systems and different scenarios, a data channel and a control channel may have different names. This is not limited in embodiments of this disclosure.

It may be understood that, in this embodiment of this disclosure, the processor may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor.

The method steps in embodiments of this disclosure may be implemented in hardware, or may be implemented in software instructions that can be executed by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to the processor, so that the processor can read information from the storage medium and write information into the storage medium. The storage medium may alternatively be a component of the processor. The processor and the storage medium may be disposed in an ASIC. In addition, the ASIC may be located in the network device or the terminal. Alternatively, the processor and the storage medium may exist in the network device or the terminal as discrete components.

All or a part of the foregoing embodiments may be implemented by software, hardware, firmware, or any combination thereof. When software is used to implement embodiments, all or a part of embodiments may be implemented in a form of a computer program product. The computer program product includes one or more computer programs or instructions. When the computer programs or the instructions are loaded and executed on a computer, the procedures or functions in embodiments of this disclosure are all or partially performed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk, or a magnetic tape; may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In each embodiment of embodiments of this disclosure, unless otherwise stated or there is a logic conflict, terms and/or descriptions between different embodiments are consistent and may be mutually referenced, and technical features in different embodiments may be combined based on an internal logical relationship thereof, to form a new embodiment.

It may be understood that various numbers in embodiments of this disclosure are merely used for differentiation for ease of description, and are not used to limit the scope of embodiments of this disclosure. Sequence numbers of the foregoing processes do not mean an execution sequence, and the execution sequence of the processes should be determined based on functions and internal logic of the processes.

What is claimed is:

1. A communication method, comprising:
determining a first time-frequency resource and a second time-frequency resource, wherein the first time-frequency resource and the second time-frequency resource corresponds to a first channel, the first time-frequency resource corresponds to a non-full-duplex, the second time-frequency resource corresponds to a full-duplex, and the first time-frequency resource and the second time-frequency resource correspond to different mapping priorities; and
sending a first signal based on the first time-frequency resource and the second time-frequency resource.

2. The method according to claim 1, wherein the first signal comprises demodulation reference signals (DMRSs), and the DMRSs are mapped to the first time-frequency resource in a first mapping manner, the DMRSs are mapped to the second time-frequency resource in a second mapping manner, and a mapping priority corresponding to the first mapping manner is different from a mapping priority corresponding to the second mapping manner.

3. The method according to claim 1, wherein the first signal comprises data signals, and a mapping priority of the data signals mapped to the first time-frequency resource is different from a mapping priority of the data signals mapped to the second time-frequency resource.

4. The method according to claim 2, wherein a density of a resource occupied by the DMRSs on the first time-frequency resource is lower than a density of a resource occupied by the DMRSs on the second time-frequency resource.

5. The method according to claim 2, wherein time domain densities of the DMRSs on different time-frequency resources are the same, and a frequency domain density of the DMRSs on the first time-frequency resource is lower than a frequency domain density of the DMRSs on the second time-frequency resource.

6. The method according to claim 2, wherein frequency domain densities of the DMRSs on different time-frequency resources are the same, and a time domain density of the DMRSs mapped to the first time-frequency resource is lower than a time domain density of the DMRSs on the second time-frequency resource.

7. The method according to claim 2, wherein a frequency domain density of the DMRSs on the first time-frequency resource is lower than a frequency domain density of the DMRSs on the second time-frequency resource, and a time domain density of the DMRSs on the first time-frequency resource is lower than a time domain density of the DMRSs on the second time-frequency resource.

8. The method according to claim 1, wherein the first signal comprises first demodulation reference signals (DMRSs) and second DMRSs, and the method further comprises:
receiving third information, wherein the third information is used to indicate that the first DMRSs are mapped to the first time-frequency resource and the second time-frequency resource; and
receiving fourth information, wherein the fourth information is used to indicate that the second DMRSs are mapped to the second time-frequency resource.

9. The method according to claim 8, further comprising:
performing at least one of rate matching or puncturing, on a time-frequency resource symmetric to the second DMRSs.

10. The method according to claim 1, wherein the first signal comprises demodulation reference signals (DMRSs), and the method further comprises:
receiving fifth information, wherein the fifth information is used to determine a mapping manner corresponding to the DMRSs; and
a density of a resource occupied by the DMRSs is a first value, and the mapping manner corresponding to the DMRSs is represented in the following manner: a density of a resource occupied by the DMRSs on the second time-frequency resource is higher than a density of a resource occupied by the DMRSs on the first time-frequency resource.

11. The method according to claim 10, wherein the the first signal comprises comprise first-type data signals and second-type data signals, a data priority of the first-type data signals is different from a data priority of the second-type data signals, and an order in which different data signals are sequentially mapped to the first time-frequency resource and the second time-frequency resource is determined based on the data priorities.

12. The method according to claim 1, wherein the first signal comprises data signals; and
sending the data signals based on the first time-frequency resource and the second time-frequency resource meets at least one of:
a quantity of retransmissions corresponding to the data signals transmitted on the second time-frequency resource is greater than a quantity of retransmissions corresponding to the data signals transmitted on the first time-frequency resource;
a modulation and coding scheme (MCS) for transmitting the data signals on the second time-frequency resource is lower than an MCS for transmitting the data signals on the first time-frequency resource; and
a quantity of layers for transmitting transmit the data signals on the second time-frequency resource is less than a quantity of layers for transmitting the data signals on the first time-frequency resource.

13. The method according to claim 1, wherein the different time-frequency resources are determined in any one of the following manners:
predefined in a protocol; or
determined through division based on a channel measurement result.

14. A communication method, comprising:
determining a first time-frequency resource and a second time-frequency resource, wherein the first and second time-frequency resources correspond to different mapping priorities; and
sending a first signal based on the first and second time-frequency resources.

15. The method according to claim 14, wherein the first signal comprises demodulation reference signals (DMRS) and densities of the DMRSs are determined based on mapping priorities corresponding to the first and second time-frequency resources.

16. The method according to claim 14, wherein the first signal comprises data signals and a sequence of mapping the data signals to the first and second time-frequency resources is determined based on the mapping priorities corresponding to the first and second time-frequency resources.

17. The method according to claim 16, wherein the data signals have data priorities, and a sequence of mapping the data signals to the first and second time-frequency resources is determined based on the data priorities and the mapping priorities corresponding to the first and second time-frequency resources.

18. The method according to claim 14, wherein the first and second time-frequency resources are obtained in at least one of the following manners:
determining the at least two time-frequency resources based on a channel measurement result and at least one measurement result threshold; and
obtaining the at least two time-frequency resources in a protocol-predefined manner.

19. A communication apparatus, comprising at least one processor coupled to a memory, wherein the memory is configured to store computer instructions, and the processor is configured to execute the computer instructions, to cause the communication apparatus to:
determine a first time-frequency resource and a second time-frequency resource, wherein the first time-frequency resource and the second time-frequency resource corresponds to a first channel, the first time-frequency resource corresponds to a non-full-duplex, the second time-frequency resource corresponds to a full-duplex, and the first time-frequency resource and the second time-frequency resource correspond to different mapping priorities; and
send a first signal based on the first time-frequency resource and the second time-frequency resource.

20. The communication apparatus according to claim 19, wherein the first signal comprises demodulation reference signals (DMRSs), and the DMRSs are mapped to the first time-frequency resource in a first mapping manner, the DMRSs are mapped to the second time-frequency resource in a second mapping manner, and a mapping priority corresponding to the first mapping manner is different from a mapping priority corresponding to the second mapping manner.
